(19) United States
(12) Patent Application Publication
(10) Pub. No.: US 2019/0309225 A1
(43) Pub. Date: Oct. 10, 2019

(54) LIQUID CRYSTALLINE MEDIUM

(71) Applicant: Merck Patent GmbH, Darmstadt (DE)

(72) Inventors: Michael WITTEK, Erzhausen (DE); Volker REIFFENRATH, Rossdorf (DE)

(73) Assignee: Merck Patent GmbH, Darmstadt (DE)

(21) Appl. No.: 16/467,086

(22) PCT Filed: Dec. 6, 2017
(86) PCT No.: PCT/EP2017/081630

§ 371 Date: Jun. 6, 2019

(30) Foreign Application Priority Data
Dec. 9, 2016 (EP) 16203219.7

(51) Int. Cl. C09K 19/34; C09K 19/30

(52) U.S. Cl. CPC C09K 19/3402; C09K 2019/0466; C09K 2019/3422; C09K 19/3066

(57) ABSTRACT

The invention relates to dielectrically positive liquid crystalline media comprising a compound of formula I

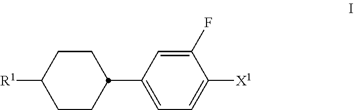

wherein R¹ denotes alkenyl having 2 to 12 C atoms, and X¹ denotes H, F or alkyl having 1 to 6 C atoms,
and to liquid crystal displays comprising these media, especially to active matrix displays and in particular to TN, FFS and IPS mode displays.

The present invention relates to liquid crystalline media and to liquid crystal displays comprising these media, especially to displays addressed by an active matrix and in particular to displays of the Twisted Nematic, the In Plane Switching (IPS) and Fringe Field Switching (FFS) type.

Liquid Crystal Displays (LCDs) are widely used to display information. LCDs are used for direct view displays, as well as for projection type displays. Electro-optical modes employed are e.g. the twisted nematic (TN)-, the super twisted nematic (STN)-, the optically compensated bend (OCB)- and the electrically controlled birefringence (ECB)-mode with their various modifications, and others. All these modes use an electrical field, which is substantially perpendicular to the substrates and to the liquid crystal layer. Besides these modes there are also electro-optical modes employing an electrical field substantially parallel to the substrates, respectively the liquid crystal layer, like e.g. the In-Plane Switching mode (as disclosed e.g. in DE 40 00 451 and EP 0 588 568). Especially this electro-optical mode is used for LCDs for modern desktop monitors and TV applications. The liquid crystals according to the present invention are preferably used in this type of displays.

Furthermore, so-called FFS (“fringe-field switching”) displays have been reported (see, inter alia, S. H. Jung et al., Jpn. J. Appl. Phys., Volume 43, No. 3, 2004, 1028), which contain two electrodes on the same substrate, one of which is structured in a comb-shaped manner and the other is unstructured. A strong, so-called “fringe field” is thereby generated, i.e. a strong electric field close to the edge of the electrodes, and, throughout the cell, an electric field which has both a strong vertical component and also a strong horizontal component. FFS displays have a low viewing-angle dependence of the contrast. FFS displays usually contain an LC medium with positive dielectric anisotropy, and an alignment layer, usually of polyimide, which provides planar alignment to the molecules of the LC medium.

For these displays new liquid crystalline media with improved properties are required. Especially the response times have to be improved for many types of applications. Thus, liquid crystalline media with lower viscosities (η), especially with lower rotational viscosities (γ₁) are required. Besides these parameters, the media have to exhibit a suitably wide range of the nematic phase, an appropriate birefringence (Δn) and dielectric anisotropy (Δε) where the latter should be high enough to allow a reasonably low operation voltage. Another requirement of utmost importance is the existence of a nematic phase of the media over a broad temperature range to allow for applications at elevated temperatures well above ambient temperature, for example at 70° C., as well as at low temperatures, for example at −30° C. Especially upon cooling, the formation of smectic phases or crystallisation is undesired and may even lead to the destruction of a display device. The existence of a nematic phase without formation of smectic phases or crystallisation at low temperatures and over a period of time sufficient for the operation of a device is referred to as low temperature stability (LTS).

The displays according to the present invention are preferably addressed by an active matrix (active matrix LCDs, short AMDs), preferably by a matrix of thin film transistors (TFTs). However, the inventive liquid crystals can also beneficially be used in displays with other known addressing means.

There are various different display modes using composite systems of liquid crystal materials of low molecular weight together with polymeric materials. These are e.g. polymer dispersed liquid crystal (PDLC)-, nematic curvi-linearly aligned phase (NCAP)- and polymer network (PN)-systems, as disclosed for example in WO 91/05 029 or axially symmetric microdomain (ASM) systems and others. In contrast to these, the modes especially preferred according to the instant invention are using the liquid crystal medium as such, oriented on surfaces. These surfaces typically are pre-treated to achieve uniform alignment of the liquid crystal material The display modes according to the instant invention preferably use an electrical field substantially parallel to the composite layer.

Liquid crystal compositions suitable for LCDs and especially for IPS displays are known e. g. from JP 07-181 439 (A), EP 0 667 555, EP 0 673 986, DE 195 09 410, DE 195 28 106, DE 195 28 107, WO 96/23 851 and WO 96/28 521. These compositions, however, do have significant drawbacks. Most of them, amongst other deficiencies, lead to unfavourably long response times, have too low values of the resistivity and/or require operation voltages, which are too high.

Thus, there is a significant need for liquid crystalline media with suitable properties for practical applications such as a wide nematic phase range, appropriate optical anisotropy Δn, according to the display mode used, a high Δε, low viscosities and high LTS.

Surprisingly, it has now been found that liquid crystalline media with a suitably high Δε, a suitable phase range and Δn and high LTS can be realized which do not exhibit the drawbacks of the materials of the prior art or at least do exhibit them to a significantly lesser degree by using liquid crystalline media comprising one or more compounds of formula I:

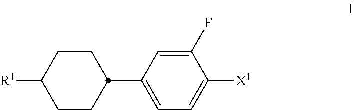

wherein
R¹ denotes alkenyl having 2 to 12 C atoms, preferably having 2 to 7 C atoms,
X¹ denotes H, F or alkyl having 1 to 6 C atoms, preferably F or methyl.

The media according to the invention are particularly useful in applications where good LTS is necessary.

Preferred compounds of formula I are selected from the group of compounds of the formulae I-1 to I-3, preferably I-3:

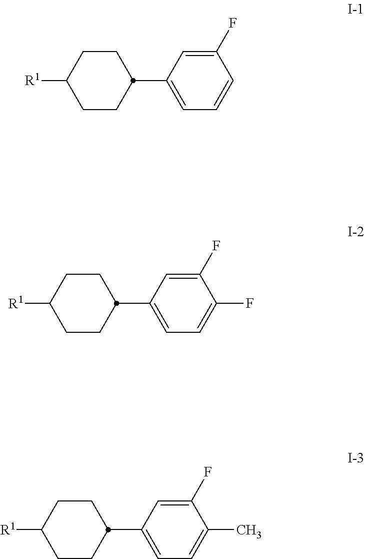

where R¹ denotes alkenyl having 2 to 7 C atoms,
preferably CH₂═CH₂—, trans-CH₃—CH═CH₂— or trans-C₂H₅—CH═CH₂—.

In a preferred embodiment of the present invention the medium comprises one or more compounds selected from the group of compounds of the formulae II and III:

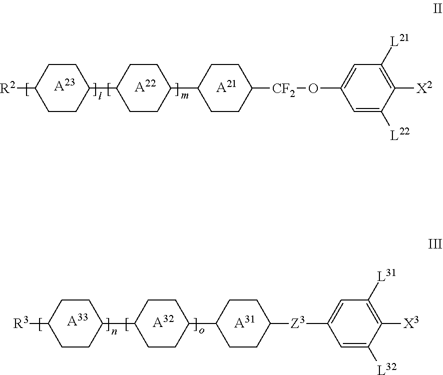

wherein
R² and R³ independently of each other, denote alkyl, alkoxy, fluorinated alkyl or fluorinated alkoxy with 1 to 7 C-atoms, alkenyl, alkenyloxy, alkoxyalkyl or fluorinated alkenyl with 2 to 7 C-atoms, preferably alkyl or alkenyl,

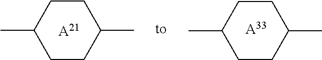

are independently of each other

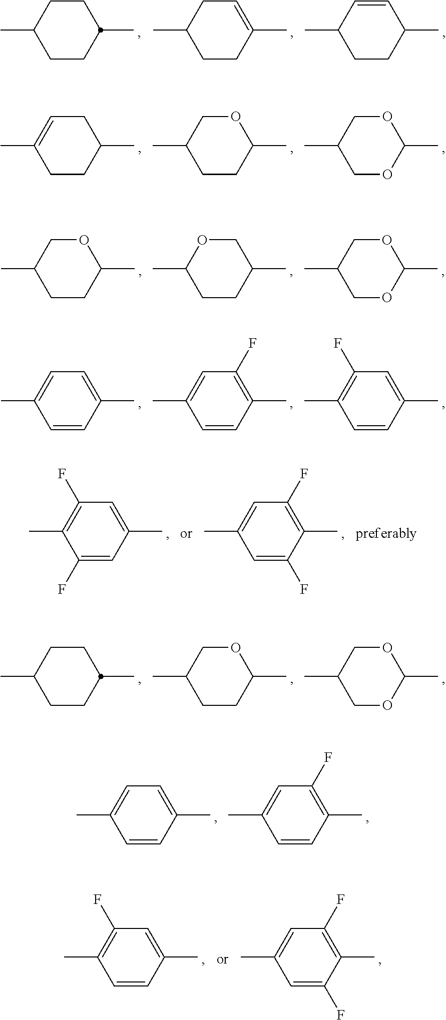

L²¹, L²², L³¹ and L³² independently of each other, denote H or F, preferably F
X² and X³ independently of each other, denote halogen, halogenated alkyl or alkoxy with 1 to 3 C-atoms or halogenated alkenyl or alkenyloxy with 2 or 3 C-atoms, preferably F, Cl, —OCF₃ or —CF₃, most preferably F, Cl or —OCF₃,
Z³ denotes —CH₂CH₂—, —CF₂CF₂—, —COO—, trans- —CH═CH—, trans-CF═CF—, —CH₂O— or a single bond,
   preferably —CH₂CH₂—, —COO—, trans- —CH═CH— or a single bond and most preferably —COO—, trans- —CH═CH— or a single bond, and
l, m, n and o are, independently of each other, 0 or 1,
   and where the compounds of formula I are excluded from the compounds of formula III.

In a preferred embodiment of the present invention the medium comprises one or more compounds of formula IV:

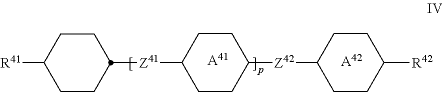

wherein
R⁴¹ and R⁴² independently of each other have the meaning given for R² under formula II above, preferably R⁴¹ is alkyl and R⁴² is alkyl or alkoxy or R⁴¹ is alkenyl and R⁴² is alkyl,

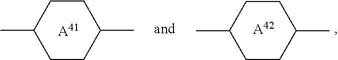

independently of each other, and in case

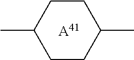

is present twice, also these, independently of each other, are

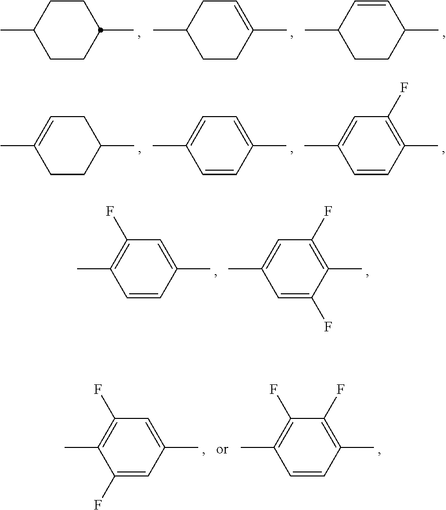

preferably at least one of

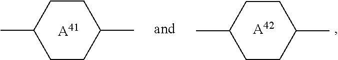

is,

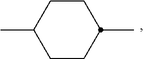

Z⁴¹, Z⁴² independently of each other, and in case Z⁴¹ is present twice, also these independently of each other, denote —CH₂CH₂—, —COO—, trans- —CH═CH—, trans- —CF═CF—, —CH₂O—, —CF₂O—, —C≡C— or a single bond, preferably at least one of them is a single bond, and
p is 0, 1 or 2, preferably 0 or 1,
   and where compounds of formula I are excluded.

The compounds of formula II are preferably selected from the group of compounds of formulae II-1 to II-3

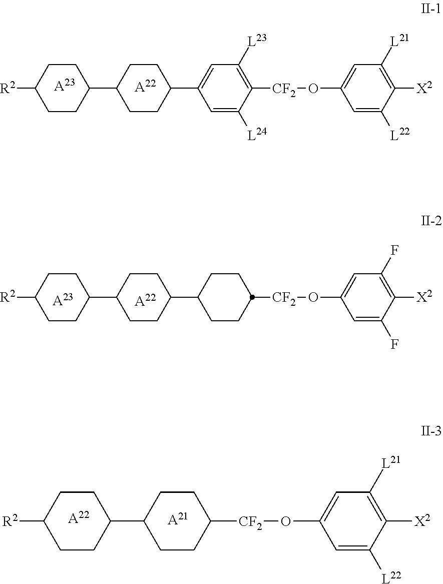

wherein the occurring groups have the respective meanings given under formula II above and in formula II-1 the group L²³ and L²⁴ denote, independently of each other, H or F and in formula II-2 preferably

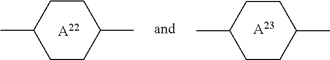

denote, independently of one another

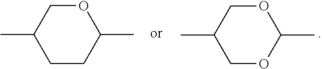

In formulae II-1 to II-3, L²¹ and L²² or L²³ and L²⁴ are preferably both F.

In another preferred embodiment, in formulae II-1 and II-2, all of L²¹, L²², L²³ and L²⁴ denote F.

The compounds of formula II-1 are preferably selected from the group of compounds of formulae II-1a to II-1g, particularly preferably from the group of compounds of formulae II-1a, II-1f and II-1g

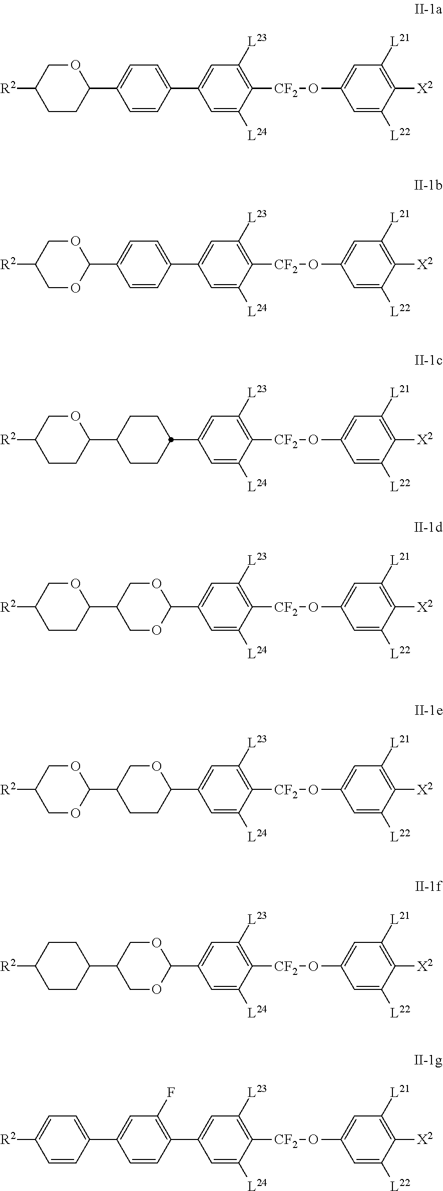

wherein the occurring groups have the respective meanings given above.

In a preferred embodiment of the present invention the medium comprises compounds selected from the group of compounds of formulae II-1a to II-1g wherein L²¹ and L²² or L²³ and L²⁴ are both F.

In another preferred embodiment the medium comprises compounds selected from the group of compounds of formulae II-1a to II-1g, wherein L²¹, L²², L²³ and L²⁴ all are F.

Especially preferred compounds of formula II-1 are

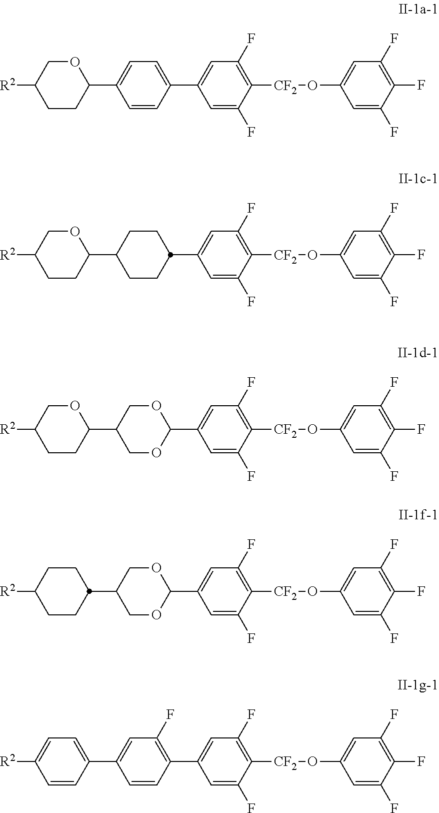

wherein the R² has the meaning given above.

Preferably the compounds of formula II-2 are selected from the group of compounds of formulae II-2a to II-2c

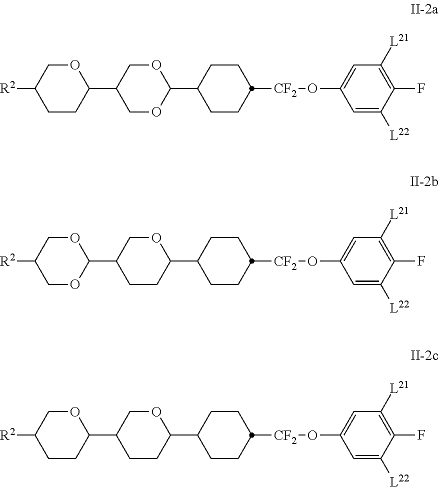

wherein the occurring groups have the respective meanings given above and preferably
L²¹ and L²² are both F.

Preferably the compounds of formula II-3 are selected from the group of compounds of formulae II-3a to II-3e, particularly preferably from the group of compounds of formulae II-3a and II-3d

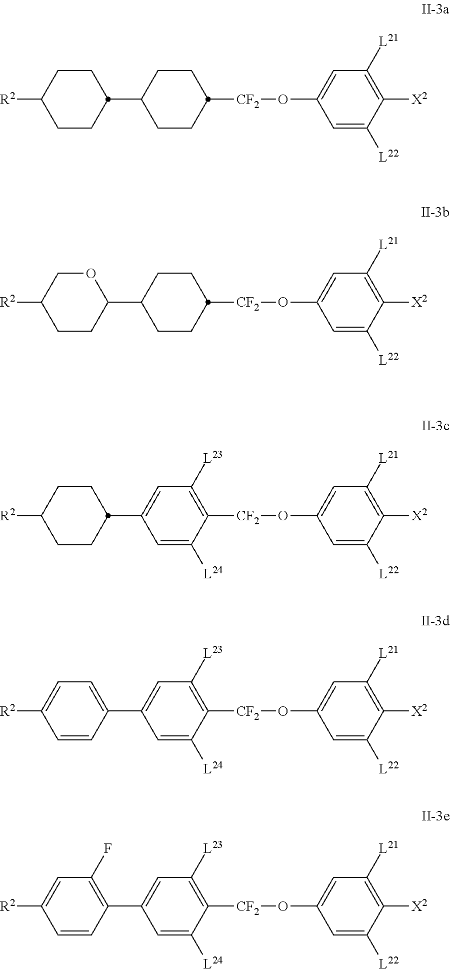

wherein the occurring groups have the respective meanings given above and preferably
L²¹ and L²² are both F and L²³ and L²⁴ are both H or
L²¹, L²², L²³ and L²⁴ are all F.

Especially preferred compounds of formula II-3 are

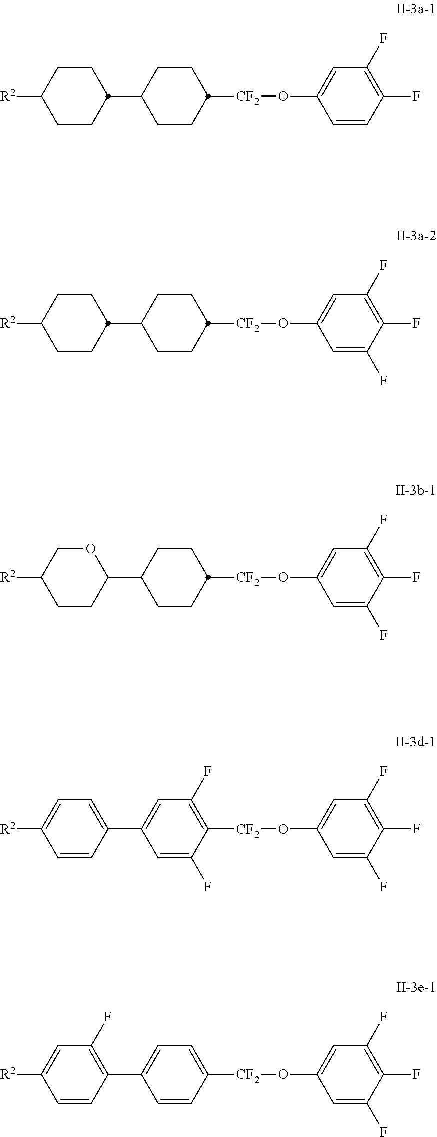

wherein the R² has the meaning given above.

In another preferred embodiment of the present invention compounds of formula III are selected from the group of formulae III-1 and III-2

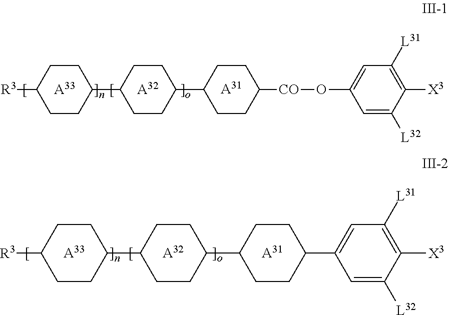

wherein the occurring groups have the respective meanings given under formula III above and where the compounds of formula I are excluded from formula III-2.

Preferably the compounds of formula III-1 are selected from the group of compounds of formulae III-1a and III-1b

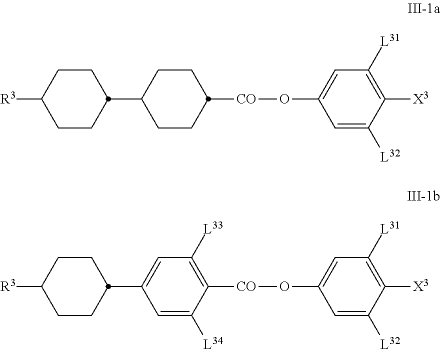

wherein the occurring groups have the respective meanings given above and L³³ and L³⁴, independently of one another, denote H or F.

Preferably the compounds of formula III-2 are selected from the group of compounds of formulae III-2a to III-2i

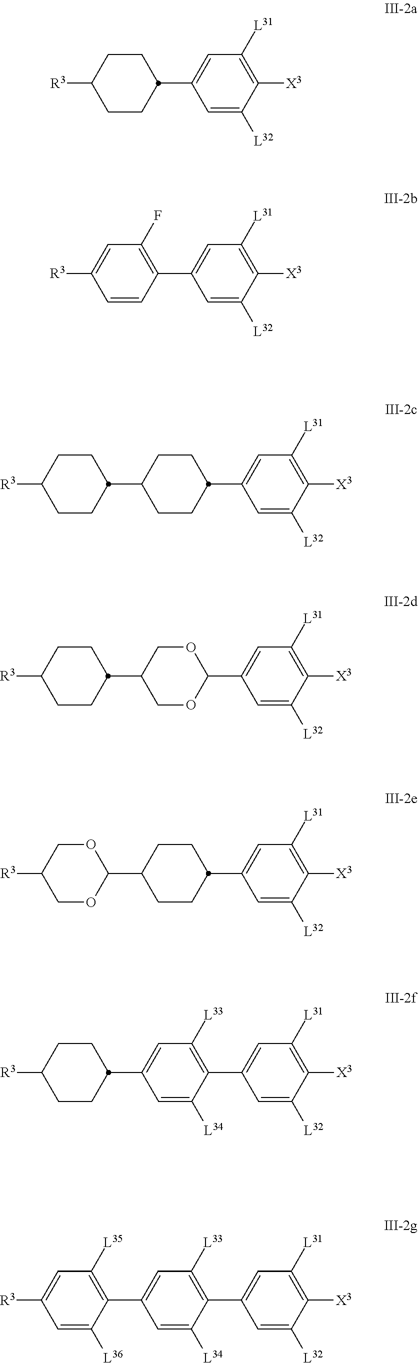

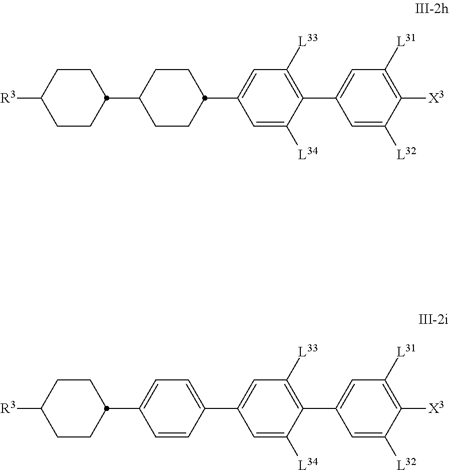

wherein the occurring groups have the respective meanings given above and L³⁵ and L³⁶, independently of one another, denote H or F, and where the compounds of formula I are excluded.

The compounds of formula
III-1a, are preferably selected from the group of compounds of formulae III-1a-1 to III-1a-6

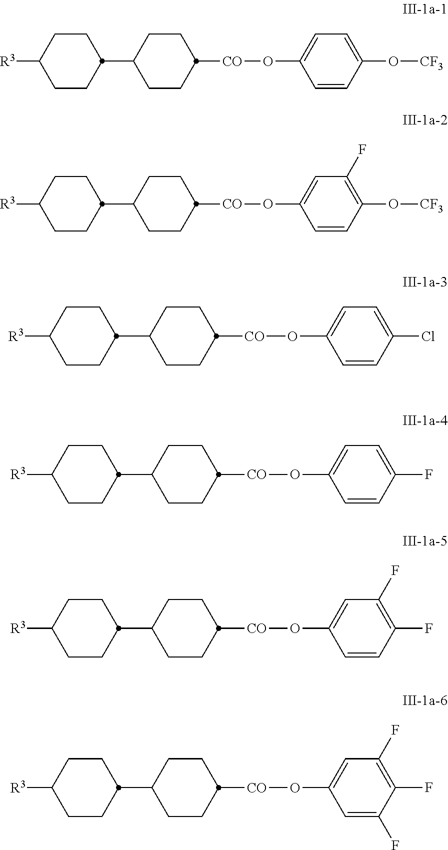

wherein the R³ has the meaning given above.

In another preferred embodiment the compounds of formula III-2a are selected from the group of compounds of formulae III-2a-1 to III-2a-4

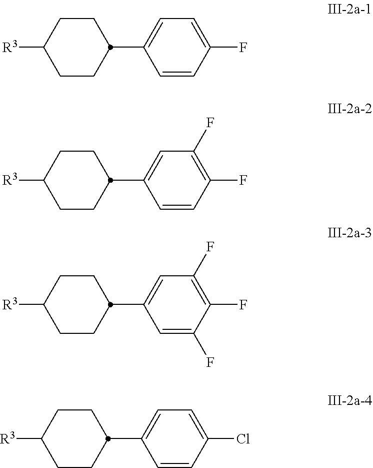

wherein the R³ has the meaning given above.

The compounds of formula III-2b are preferably selected from the group of compounds of formulae III-2b-1 and III-2b-2, preferably III-2b-2

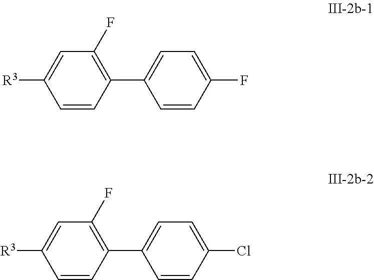

wherein the R³ has the meaning given above.

The compounds of formula II-2c, are preferably selected from the group of compounds of formulae III-2c-1 to III-2c-5

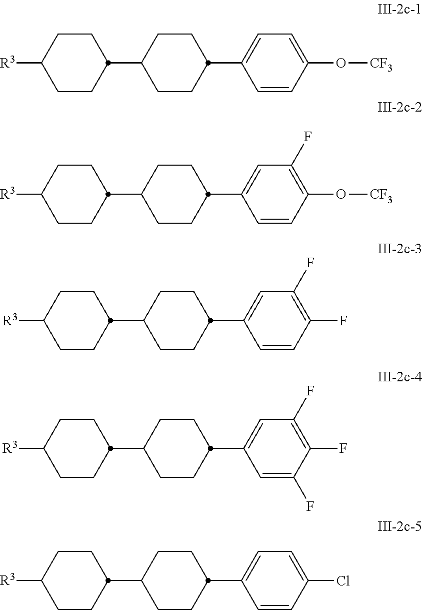

wherein the R³ has the meaning given above.

The compounds of formulae III-2d and III-2e are preferably selected from the group of compounds of formulae III-2d-1 and III-2e-1

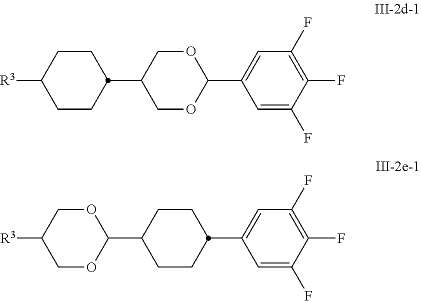

wherein the R³ has the meaning given above.

The compounds of formula III-2f are preferably selected from the group of compounds of formulae III-2f-1 to III-2f-7

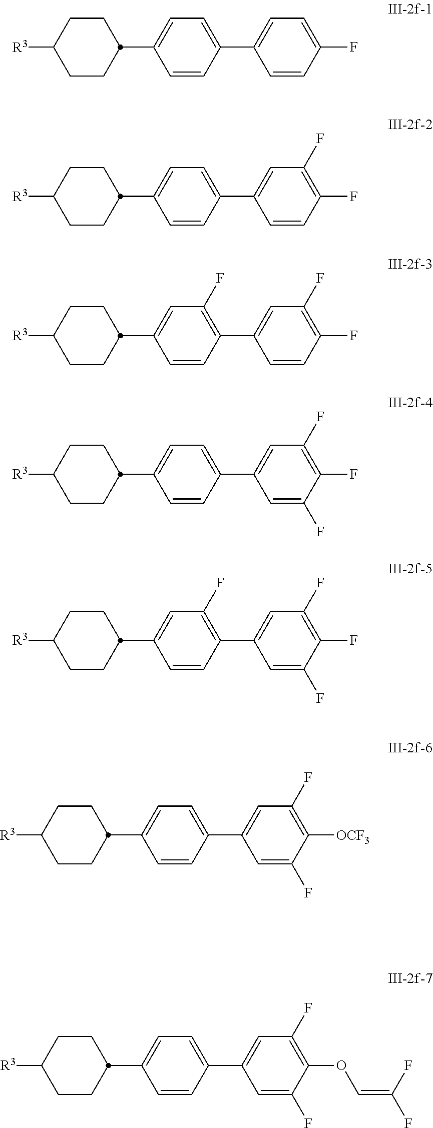

wherein the R³ has the meaning given above.

The compounds of formula III-2g, are preferably selected from the group of compounds of formulae III-2g-1 to III-2g-5

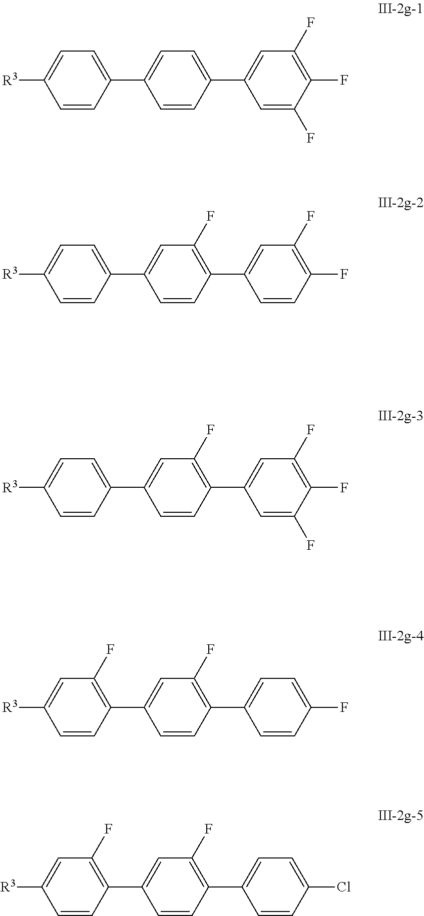

wherein the R³ has the meaning given above.

The compounds of formula III-2h are preferably selected from the group of compounds of formulae III-2h-1 to III-2h-3

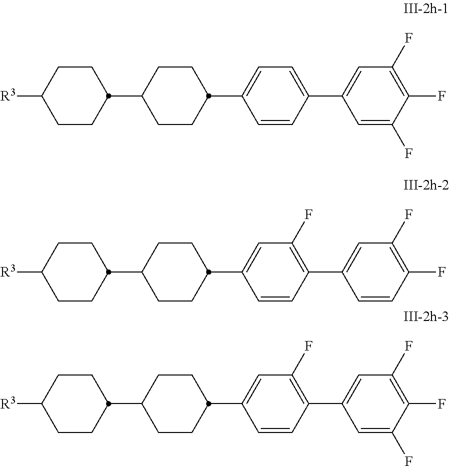

wherein the R³ has the meaning given above.

The compounds of formula III-2i are preferably selected from the group of compounds of formulae III-2i-1 to III-2i-6

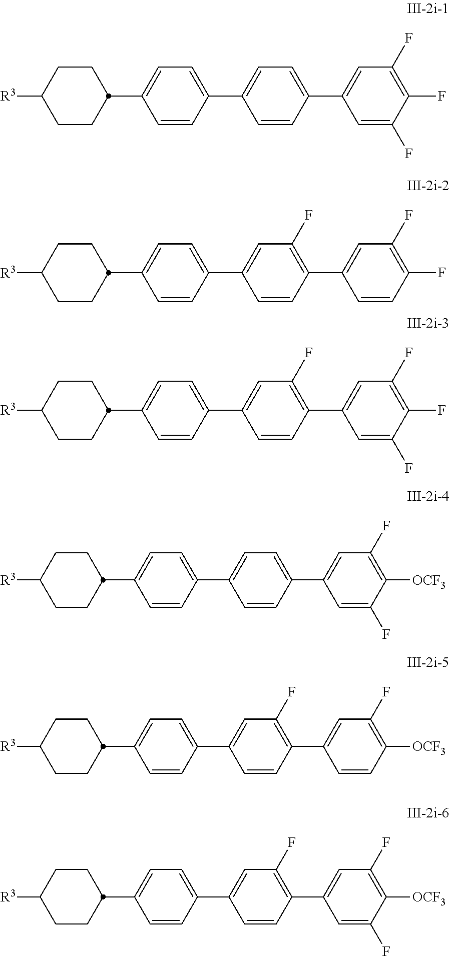

wherein the R³ has the meaning given above.

Alternatively or additionally to compounds of formulae III-1 and/or III-2 the media according to the present invention my comprise one or more compounds of formula III-3,

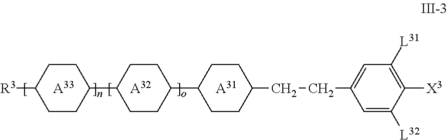

wherein the occurring groups have the respective meanings given under formula III above,
and preferably of formula III-3a

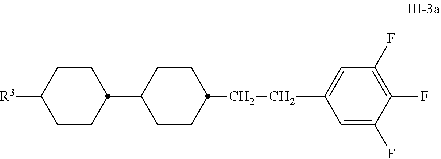

wherein the R³ has the meaning given above.

Preferably the liquid crystalline media according to the present invention comprise one or more compounds of formula IV preferably selected from the group of compounds of formulae IV-1 to IV-5

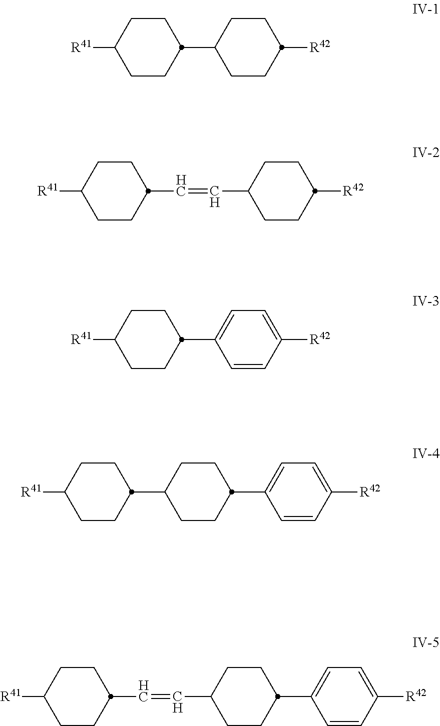

wherein R⁴¹ and R⁴² have the respective meanings given under formula IV above and in formulae IV-1, IV-4 and IV-5 R⁴¹ preferably is alkyl or alkenyl, preferably alkenyl and R⁴² preferably is alkyl or alkenyl, preferably alkyl; in formula IV-2 R⁴¹ and R⁴² preferably are alkyl and in formula IV-3 R⁴¹ preferably is alkyl or alkenyl, preferably alkyl and R⁴² preferably is alkyl or alkoxy, preferably alkoxy.

In a preferred embodiment, the medium comprises one or more compounds of formula IV-1, more preferably selected from its respective subformulae of formula CC-n-V and/or CC-nV-m, more preferably of formula CC-n-V and most preferably of formula CC-3-V. The definitions of these abbreviations (acronyms) are given in table B below.

In a preferred embodiment, the medium comprises one or more compounds of formula IV-4, more preferably selected from its respective subformulae of formula CCP-V-n and/or CCP-nV-m and/or CCP-Vn-m, more preferably of formula CCP-V-n and/or CCP-V2-n and most preferably selected from the group of formulae CCP-V-1 and CCP-V2-1. The definitions of these abbreviations (acronyms) are given in table B below.

Preferably the medium comprises compounds selected from the group of compounds of formulae IV-1, IV-3, IV-4 and IV-5, preferably one or more compounds of formula IV-1 and one or more compounds selected from the group of formulae IV-3 or IV-4.

Optionally it can be preferred that the medium further comprises one or more compounds of formula IV selected from the group of compounds of formulae IV-6 to IV-13

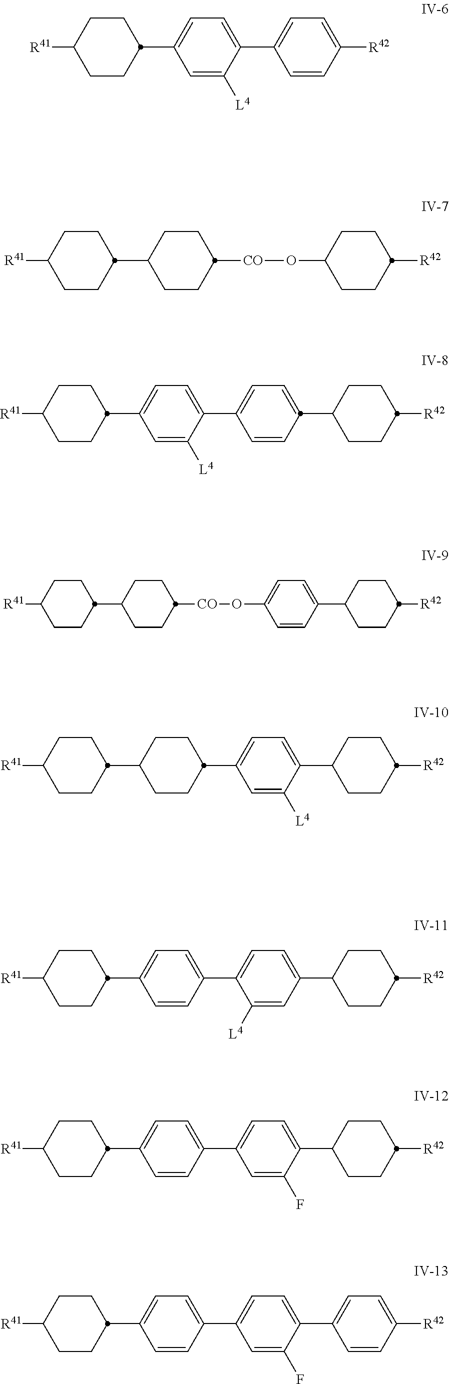

wherein
R⁴¹ and R⁴² independently of each other, denote alkyl, alkoxy, fluorinated alkyl or fluorinated alkoxy with 1 to 7 C-atoms, alkenyl, alkenyloxy, alkoxyalkyl or fluorinated alkenyl with 2 to 7 C-atoms and
L⁴ denotes H or F.

Alternatively or additionally to compounds of formulae II and/or III the media according to the present invention my comprise one or more compounds of formula V

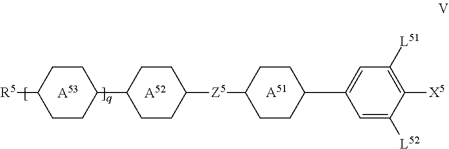

wherein
R⁵ is alkyl, alkoxy, fluorinated alkyl or fluorinated alkoxy with 1 to 7 C-atoms, alkenyl, alkenyloxy, alkoxyalkyl or fluorinated alkenyl with 2 to 7 C-atoms, and preferably is alkyl or alkenyl,

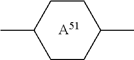

to

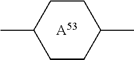

are, independently of each other,

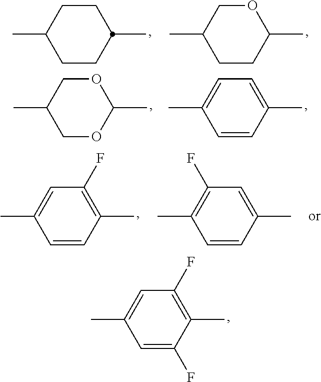

L⁵¹ and L⁵², independently of each other, denote H or F, preferably L⁵¹ denotes F and
X⁵ denotes halogen, halogenated alkyl or alkoxy with 1 to 3 C-atoms or halogenated alkenyl or alkenyloxy with 2 or 3 C-atoms, preferably F, Cl, —OCF₃ or —CF₃, most preferably F, Cl or —OCF₃,
Z⁵ denotes —CH₂CH₂—, —CF₂CF₂—, —COO—, trans- —CH═CH—, trans- —CF═CF— or —CH₂O, preferably —CH₂CH₂—, —COO— or trans- —CH═CH— and most preferably —COO— or —CH₂CH₂—, and
q is 0 or 1.

Preferably the media according to the present invention comprises one or more compounds of formula V, preferably selected from the group of compounds of formulae V-1 and V-2

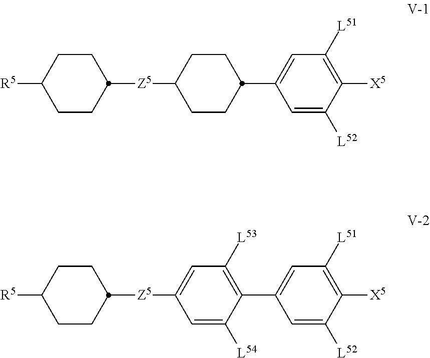

wherein the occurring groups have the respective meanings given above and L⁵³ and L⁵⁴ are, independently of one another, H or F and preferably Z⁵ is —CH₂—CH₂—.

Preferably the compounds of formula V-1 are selected from the group of compounds of formulae V-1a and V-1b

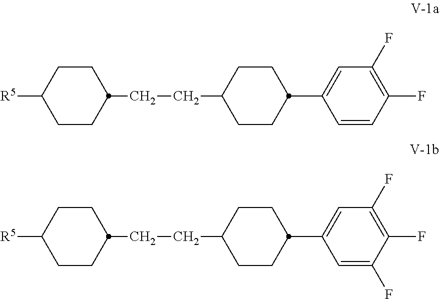

wherein the R⁵ has the meaning given above.

Preferably the compounds of formula V-2 are selected from the group of compounds of formulae V-2a to V-2d

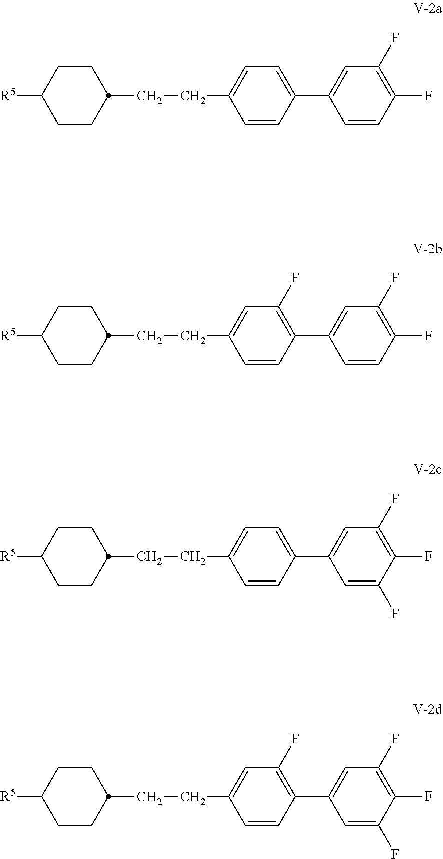

wherein the R⁵ has the meaning given above.

Preferably the liquid crystalline media according to the present invention additionally comprise one or more compounds of formula VI

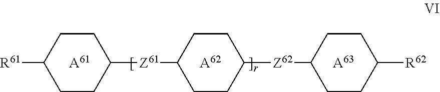

wherein
R⁶¹ and R⁶² independently of each other have the meaning given for R² under formula II above, preferably R⁶¹ is alkyl and R⁶² is alkyl or alkenyl,

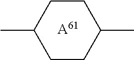

in each occurrence independently of each other, denote to

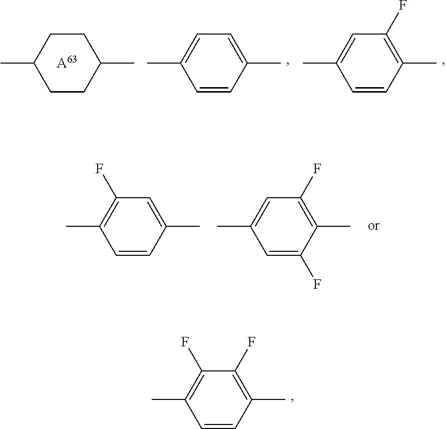

Z⁶¹ and Z⁶² are, independently of each other, and in case Z⁶¹ is present twice, also these independently of each other, —CH₂CH₂—, —COO—, trans- —CH═CH—, trans- —CF═CF—, —CH₂O—, —CF₂O— or a single bond, preferably at least one of them is a single bond, and
r is 0, 1 or 2, preferably 0 or 1.

Preferably the compounds of formula VI are selected from the group of compounds of formulae VI-1 to VI-4

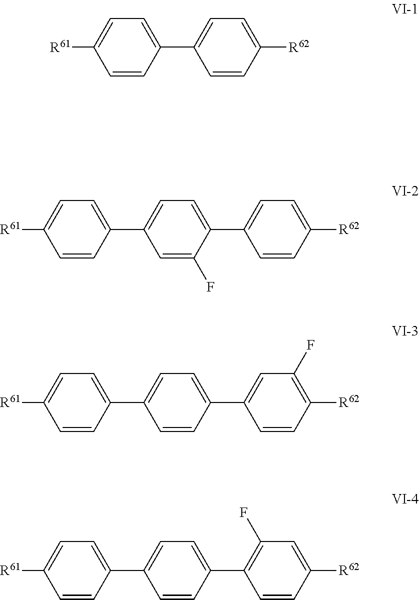

wherein R⁶¹ and R⁶² have the respective meanings given under formula VI above and R⁶¹ preferably is alkyl and in formula VI-1 R⁶² preferably is alkenyl, preferably —(CH₂)₂—CH═CH—CH₃ and in formula VI-2 R⁶² preferably is alkenyl, preferably —(CH₂)₂—CH═CH₂ and in formulae VI-3 and VI-4 R⁶² preferably is alkyl.

Preferably the medium comprises one or more compounds selected from the group of compounds of formulae VI-1 to VI-4 wherein R⁶¹ preferably is alkyl and in formula VI-1 R⁶² preferably is alkenyl, preferably —(CH₂)₂—CH═CH—CH₃ and in formula VI-2 R⁶² preferably is alkenyl, preferably —(CH₂)₂—CH═CH₂ and in formulae VI-3 and VI-4 R⁶² preferably is alkyl.

The compounds of formula VI-1 are preferably selected from its subformula PP-n-2Vm, more preferably of formula PP-1-2V1. The definitions of these abbreviations (acronyms) are given in table B below.

In a preferred embodiment, the medium comprises one or more compounds of formula VI-2, more preferably of its subformula PGP-n-m, more preferably of its subformulae PGP-2-m and PGP-3-m, more preferably selected from of formulae PGP-2-2V, PGP-3-2, PGP-3-3, PGP-3-4, PGP-3-5.

The definitions of these abbreviations (acronyms) are given in table B below.

Preferably the liquid crystalline medium according to the instant invention comprises one or more compounds of formula I and II, preferably of formula II-1 and/or II-3.

In a preferred embodiment, the medium comprises one or more compounds of formula I, II, III, IV and VI.

In a preferred embodiment, the medium comprises one or more compounds of formula II-1a and/or II-1g

In a preferred embodiment, the medium comprises one or more compounds of formula III-2, preferably selected from the group of compounds of the formulae III-2c and III-2f.

In a preferred embodiment, the medium comprises one or more compounds selected from the group of compounds of the formulae III-2c and III-2f and one or more compounds selected from the group of compounds of the formulae III-2h and III-2i.

In a preferred embodiment, the medium comprises one or more compounds of the formula VI-2.

In a preferred embodiment the medium comprises one or more compounds of formula IV, more preferably of formula IV-1, more preferably selected from its respective subformulae of formula CC-n-V and/or CC-n-Vm, more preferably of formula CC-n-V1 and/or CC-n-V and most preferably selected from the group of formulae CC-3-V, CC-4-V, CC-5-V and CC-3-V1.

Also other mesogenic compounds, which are not explicitly mentioned above, can optionally and beneficially be used in the media according to the instant invention. Such compounds are known to the expert in the field.

The Δn of the liquid crystal media according to the instant invention preferably is in the range of 0.070 or more to 0.145 or less, more preferably in the range of 0.080 or more to 0.140 or less and most preferably in the range of 0.090 or more to 0.135 or less.

The Δε of the liquid crystal medium according to the invention preferably is 4 or more, more preferably 6 or more and most preferably 8 or more.

The Δε of the liquid crystal medium according to the invention is 20 or less, preferably 17 or less, more preferably 14 or less.

In a preferred embodiment of the present invention the Δε of the liquid crystal medium is in the range of from 2 to 12, more preferably from 3 to 10 and particularly preferably 4 to 8.

In another preferred embodiment of the present invention the Δε of the liquid crystal medium is in the range of from 6 to 18, more preferably from 8 to 16 and particularly preferably from 10 to 14.

The rotational viscosity of the medium according to the present invention is 120 mPa·s or less, preferably 100 mPa·s or less and particularly preferably 80 mPa·s or less.

The liquid-crystal media in accordance with the present invention preferably have a clearing point of 70° C. or more, more preferably 75° C. or more and particularly preferably 80° C. or more.

The liquid-crystal media in accordance with the present invention preferably have a clearing point of 120° C. or less, more preferably 110° C. or less, particularly preferably 100° C. or less.

The nematic phase of the media according to the invention preferably extends at least from −10° C. or less to 70° C. or more. It is advantageous for the media according to the invention to exhibit even broader nematic phase ranges, preferably at least from −20° C. or less to 75° C. or more, very preferably at least from −30° C. or less to 85° C. or more and in particular at least from −40° C. or less to 95° C. or more.

Preferably the storage stability of the inventive media at a temperature of −20° C. in the bulk (LTS_{bulk}) is 120 h or more, more preferably 500 h or more and most preferably 1,000 h or more.

More preferably the storage stability of the inventive media at a temperature of −30° C. in the bulk (LTS_{bulk}) is 120 h or more, more preferably 500 h or more and most preferably 1,000 h or more.

Most preferably the storage stability of the inventive media at a temperature of −40° C. in the bulk (LTS_{bulk}) is 120 h or more, more preferably 250 h or more and most preferably 500 h or more.

The storage stability of the inventive media at a temperature of −20° C., more preferably at a temperature of −30° C., and most preferably at a temperature of −40° C., in the bulk (LTS_{cell}) is preferably 250 h or more, more preferably 500 h or more and most preferably 1,000 h or more.

The expression “to have a nematic phase” here means on the one hand that no smectic phase and no crystallisation is observed at low temperatures at the corresponding temperature within a given period of time and on the other hand that no clearing occurs on heating from the nematic phase.

The concentration of compounds of formula I in the medium preferably is in the range of from 1% to 15%, more preferably from 2% to 10% and particularly preferably from 3% to 6%.

In a preferred embodiment of the present invention,
the total concentration of compounds of formula II in the medium is in the range of from 20% to 60%, more preferably from 30% to 50% and particularly preferably from 35% to 45%;
the total concentration of compounds of formula III in the medium is in the range of from 15% to 45%, more preferably from 20% to 40% and particularly preferably from 25% to 35%;
the total concentration of compounds of formula IV in the medium is in the range of from 10% to 40%, more preferably from 15% to 35% and particularly preferably from 22% to 28%;
the total concentration of compounds of formula VI in the medium is in the range of from 10% to 30%, more preferably from 15% to 25% and particularly preferably from 17% to 22%.

In another preferred embodiment of the present invention,
the total concentration of compounds of formula II in the medium is in the range of from 10% to 30%, more preferably from 15% to 25% and particularly preferably from 17% to 22%;
the total concentration of compounds of formula III in the medium is in the range of from 2% to 20%, more preferably from 5% to 15% and particularly preferably from 8% to 12%;
the total concentration of compounds of formula IV in the medium is in the range of from 20% to 60%, more preferably from 30% to 50% and particularly preferably from 35% to 45%;
the total concentration of compounds of formula VI in the medium is in the range of from 10% to 30%, more preferably from 15% to 25% and particularly preferably from 17% to 22%;

Optionally, the inventive media can comprise further liquid crystal compounds in order to adjust the physical properties. Such compounds are known to the expert. Their concentration in the media according to the instant invention is preferably 0% to 30%, more preferably 0.1% to 20% and most preferably 1% to 15%.

The definitions of these abbreviations (acronyms) are given in table B below. In this preferred embodiment, preferably the concentration of compounds of formula IV is greater than 40%, more preferably greater than 42%, and most preferably greater than 45%.

Preferably the liquid crystal media contain 50% to 100%, more preferably 70% to 100% and most preferably 90% to 100% compounds of the formulae I to VI and preferably I to IV and VI.

In the present application the term dielectrically positive means compounds or components with Δε>3.0, dielectrically neutral with −1.5≤Δε≤3.0 and dielectrically negative with Δε<−1.5. Δε is determined at a frequency of 1 kHz and at 20° C. The dielectric anisotropy of the respective compound is determined from the results of a solution of 10% of the respective individual compound in a nematic host mixture. In case the solubility of the respective compound in the host mixture is less than 10% the concentration is reduced to 5%. The capacities of the test mixtures are determined both in a cell with homeotropic and with homogeneous alignment. The cell gap of both types of cells is approximately 20 μm. The voltage applied is a rectangular wave with a frequency of 1 kHz and a root mean square value typically of 0.5 V to 1.0 V, however, it is always selected to be below the capacitive threshold of the respective test mixture.

Δε is defined as (ε∥−ε_{⊥}), whereas ε_{av.} is (ε∥+2ε_{⊥})/3.

For dielectrically positive compounds the mixture ZLI-4792 and for dielectrically neutral, as well as for dielectrically negative compounds, the mixture ZLI-3086, both of Merck KGaA, Germany are used as host mixture, respectively. The dielectric permittivities of the compounds are determined from the change of the respective values of the host mixture upon addition of the compounds of interest. The values are extrapolated to a concentration of the compounds of interest of 100%.

Components having a nematic phase at the measurement temperature of 20° C. are measured as such, all others are treated like compounds.

The term threshold voltage refers in the instant application to the optical threshold and is given for 10% relative contrast (V₁₀, also abbreviated to V_{(10,0,20)} indicating perpendicular observation and 20° C.) and the term saturation voltage refers to the optical saturation and is given for 90% relative contrast (V₉₀, also abbreviated to V_{(90,0,20)} indicating perpendicular observation and 20° C.) both, if not explicitly stated otherwise. The capacitive threshold voltage (V₀), also called Freedericksz-threshold (V_{Fr}) is only used if explicitly mentioned.

The following abbreviations are used:
Vₒₚ=operating voltage;
tₒₙ=time after switching on until 90% of the maximum contrast is achieved, measured from 10% of the maximum contrast;
t_{off}=time after switching off until 10% of the maximum contrast is achieved, measured from 90% of the maximum contrast;

tₛᵤₘ=tₒₙ₊t_{off}.

The ranges of parameters given in this application are all including the limiting values, unless explicitly stated otherwise.

Throughout this application, unless explicitly stated otherwise, all concentrations are given in mass percent and relate to the respective complete mixture, all temperatures are given in degrees centigrade (Celsius) and all differences of temperatures in degrees centigrade. All physical properties have been and are determined according to “Merck Liquid Crystals, Physical Properties of Liquid Crystals”, Status November 1997, Merck KGaA, Germany and are given for a temperature of 20° C., unless explicitly stated otherwise. The optical anisotropy (Δn) is determined at a wavelength of 589.3 nm. The dielectric anisotropy (Δε) is determined at a frequency of 1 kHz. The threshold voltages, as well as all other electro-optical properties have been determined with test cells prepared at Merck KGaA, Germany. The test cells for the determination of Δε had a cell gap of approximately 20 μm. The electrode was a circular ITO electrode with an area of 1.13 cm² and a guard ring. The orientation layers were lecithin for homeotropic orientation (ε∥) and polyimide AL-1054 from Japan Synthetic Rubber for homogeneous orientation (ε_{⊥}). The capacities were determined with a frequency response analyser Solatron 1260 using a sine wave with a voltage of 0.3 Vᵣₘₛ. The light used in the electro-optical measurements was white light. The set up used was commercially available equipment of Otsuka, Japan. The characteristic voltages have been determined under perpendicular observation. The threshold (V₁₀)-mid grey (V₅₀)-and saturation (V₉₀) voltages have been determined for 10%, 50% and 90% relative contrast, respectively.

The storage stability in the bulk (LTS_{bulk}) of the media according to the invention at a given temperature T is determined by visual inspection. 2 g of the media of interest are filled into a closed glass vessel (bottle) of appropriate size placed in a refrigerator at a predetermined temperature. The bottles are checked at defined time intervals for the occurrence of smectic phases or crystallisation. For every material and at each temperature two bottles are stored. If crystallisation or the appearance of a smectic phase is observed in at least one of the two correspondent bottles the test is terminated and the time of the last inspection before the one at which the occurrence of a higher ordered phase is observed is recorded as the respective storage stability.

For the determination of the storage stability in LC cells (LTS_{cell}) of the media according to the present invention at a given temperature T, the media are filled into TN-type LC test cells with orientation layers, having an approximate surface area of 3 cm², an electrode area of about 3 cm² and a cell gap of 6 μm. The cells have no spacers in the area covered by the LC. Only in the edge seal spacers are used. The cells are sealed, polarizers are attached to the cells and the cells are and placed in a refrigerator with a window and internal lighting at a predetermined temperature. Generally, three cells each are filled with a given LC for each temperature investigated. The cells inside the refrigerator are inspected visually through a window defined time intervals for the occurrence of smectic phases or crystallization. Here too, the time of the last inspection before the one at which the occurrence of a higher ordered phase is observed in the first one of a given set of test cells is recorded as the respective storage stability.

The liquid crystal media according to the present invention can contain further additives and chiral dopants in usual concentrations. The total concentration of these further constituents is in the range of 0% to 10%, preferably 0.1% to 6%, based on the total mixture. The concentrations of the individual compounds used each are preferably in the range of 0.1% to 3%. The concentration of these and of similar additives is not taken into consideration for the values and ranges of the concentrations of the liquid crystal components and compounds of the liquid crystal media in this application.

The inventive liquid crystal media according to the present invention consist of several compounds, preferably of 3 to 30, more preferably of 4 to 20 and most preferably of 4 to 16 compounds. These compounds are mixed in conventional way. As a rule, the required amount of the compound used in the smaller amount is dissolved in the compound used in the greater amount. In case the temperature is above the clearing point of the compound used in the higher concentration, it is particularly easy to observe completion of the process of dissolution. It is, however, also possible to prepare the media by other conventional ways, e.g. using so called pre-mixtures, which can be e.g. homologous or eutectic mixtures of compounds or using so called multi-bottle-systems, the constituents of which are ready to use mixtures themselves.

By addition of suitable additives, the liquid crystal media according to the instant invention can be modified in such a way, that they are usable in all known types of liquid crystal displays, either using the liquid crystal media as such, like TN-, TN-AMD, ECB-AMD, VAN-AMD, IPS and OCB LCDs and in particular in composite systems, like PDLC, NCAP, PN LCDs and especially in ASM-PA LCDs.

The melting point T(C,N), the transition from the smectic (S) to the nematic (N) phase T(S,N) and the clearing point T(N,I) of the liquid crystals are given in degrees centigrade.

In the present application and especially in the following examples, the structures of the liquid crystal compounds are represented by abbreviations also called acronyms. The transformation of the abbreviations into the corresponding structures is straight forward according to the following two tables A and B. All groups CₙH₂ₙ₊₁ and CₘH₂ₘ₊₁ are straight chain alkyl groups with n respectively m C-atoms. The interpretation of table B is self-evident. Table A does only list the abbreviations for the cores of the structures. The individual compounds are denoted by the abbreviation of the core followed by a hyphen and a code specifying the substituents R¹, R², L¹ and L² follows:

| Code for | | | | |
|---|---|---|---|---|
| R¹, R², L¹, L² | R¹ | R² | L¹ | L² |
| nm | CₙH₂ₙ₊₁ | CₘH₂ₘ₊₁ | H | H |
| nOm | CₙH₂ₙ₊₁ | OCₘH₂ₘ₊₁ | H | H |
| nO.m | OCₙH₂ₙ₊₁ | CₘH₂ₘ₊₁ | H | H |
| n | CₙH₂ₙ₊₁ | CN | H | H |
| nN.F | CₙH₂ₙ₊₁ | CN | H | F |
| nN.F.F | CₙH₂ₙ₊₁ | CN | F | F |
| nF | CₙH₂ₙ₊₁ | F | H | H |
| nF.F | CₙH₂ₙ₊₁ | F | H | F |
| nF.F.F | CₙH₂ₙ₊₁ | F | F | F |
| nOF | OCₙH₂ₙ₊₁ | F | H | H |
| nCl | CₙH₂ₙ₊₁ | Cl | H | H |
| nCl.F | CₙH₂ₙ₊₁ | Cl | H | F |
| nCl.F.F | CₙH₂ₙ₊₁ | Cl | F | F |
| nCF₃ | CₙH₂ₙ₊₁ | CF₃ | H | H |
| nCF₃.F | CₙH₂ₙ₊₁ | CF₃ | H | F |
| nCF₃.F.F | CₙH₂ₙ₊₁ | CF₃ | F | F |
| nOCF₃ | CₙH₂ₙ₊₁ | OCF₃ | H | H |
| nOCF₃.F | CₙH₂ₙ₊₁ | OCF₃ | H | F |
| nOCF₃.F.F | CₙH₂ₙ₊₁ | OCF₃ | F | F |
| nOCF₂ | CₙH₂ₙ₊₁ | OCHF₂ | H | H |
| nOCF₂.F | CₙH₂ₙ₊₁ | OCHF₂ | H | F |
| nOCF₂.F.F | CₙH₂ₙ₊₁ | OCHF₂ | F | F |
| nS | CₙH₂ₙ₊₁ | NCS | H | H |
| nS.F | CₙH₂ₙ₊₁ | NCS | H | F |
| nS.F.F | CₙH₂ₙ₊₁ | NCS | F | F |
| rVsN | CᵣH₂ᵣ₊₁—CH═CH—CₛH₂ₛ— | CN | H | H |
| rEsN | CᵣH₂ᵣ₊₁—O—CₛH₂ₛ— | CN | H | H |
| nAm | CₙH₂ₙ₊₁ | COOCₘH₂ₘ₊₁ | H | H |

TABLE A

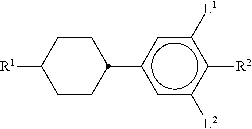

PCH

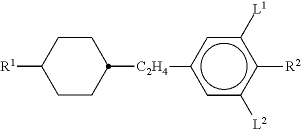

EPCH

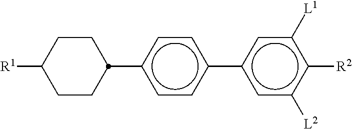

BCH

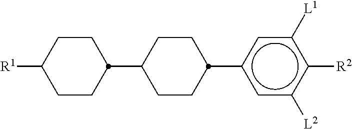

CCP

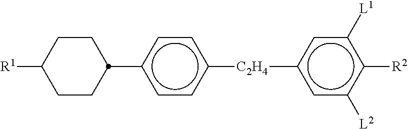

EBCH

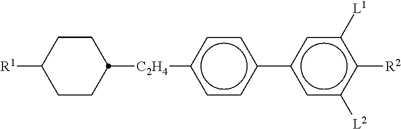

BECH

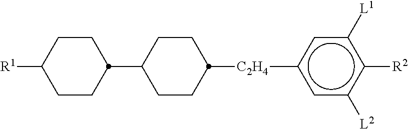

ECCP

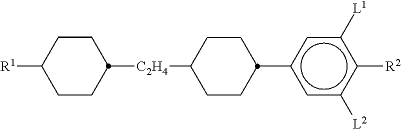

CECP

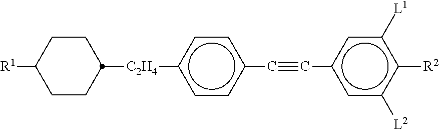

CEPTP

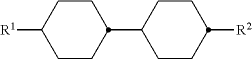

CCH

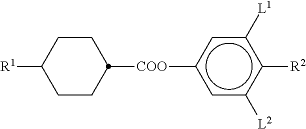

D

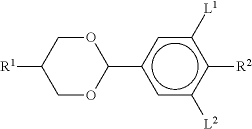

PDX

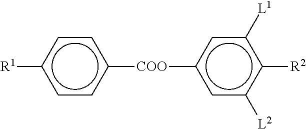

ME

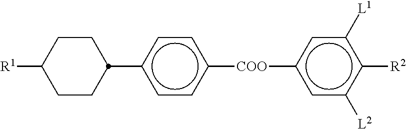

HP

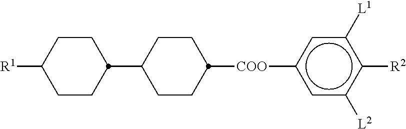

CP

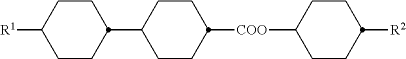

CH

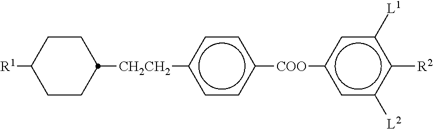

EHP

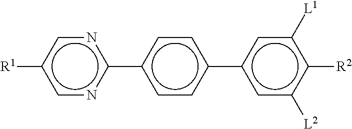

MPP

TABLE B

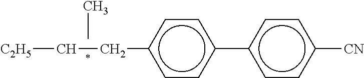

CB15

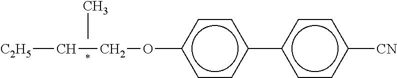

C15

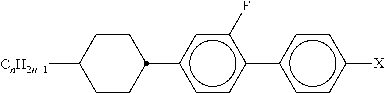

CGP-n-X
(X = F, Cl, “OT“ = OCF₃, “OD“ = OCF₂H, “T” = CF₃)

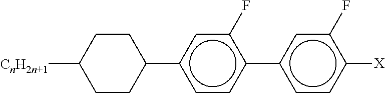

CGGn-n-X
(X = F, Cl, “OT“ = OCF₃, “OD“ = OCF₂H, “T” = CF₃)

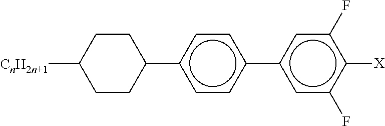

CPU-n-X
(X = F, Cl, “OT“ = OCF₃, “OD“ = OCF₂H, “OXF” = OCH═CF₂, “T” = CF₃)

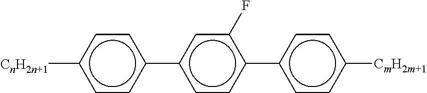

PGP-n-m

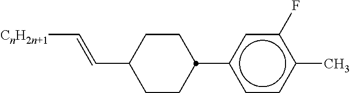

CG-nV-1

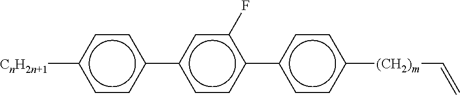

PGP-n-mV

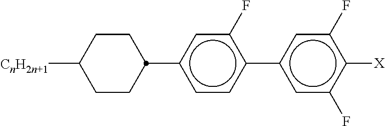

CGU-n-X
(X = F, Cl, “OT“ = OCF₃, “OD“ = OCF₂H, “T” = CF₃)

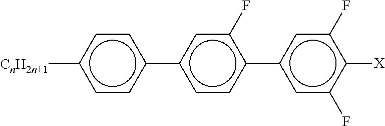

PGU-n-X
(X = F, Cl, “OT“ = OCF₃, “OD“ = OCF₂H, “T” = CF₃)

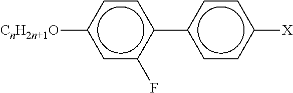

GP-n-X
(X = F, Cl, “OT“ = OCF₃, “OD“ = OCF₂H, “T” = CF₃)

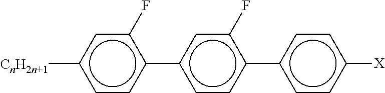

GGP-n-X
(X = F, Cl, “OT“ = OCF₃, “OD“ = OCF₂H, “T” = CF₃)

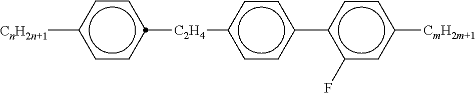

Inm

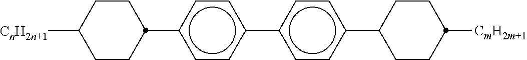

CBC-nm

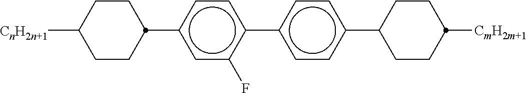

CBC-nmF

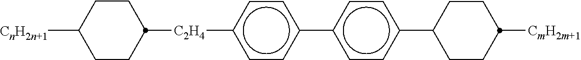

ECBC-nm

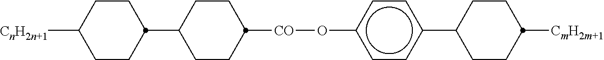

CCPC-nm

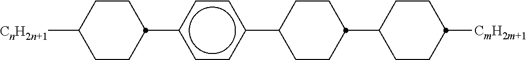

CPCC-n-m

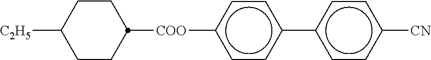

CHE

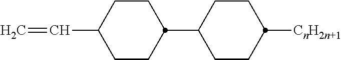

CC-n-V

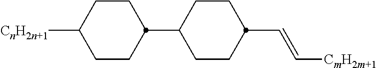

CC-n-Vm

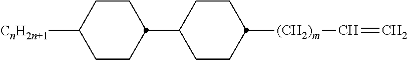

CC-n-mV

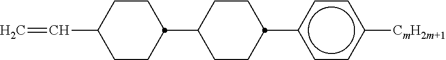

CCP-V-m

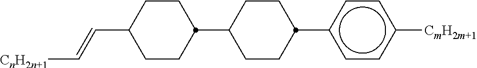

CCP-nV-m

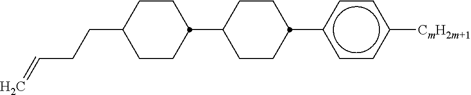

CCP-V2-m

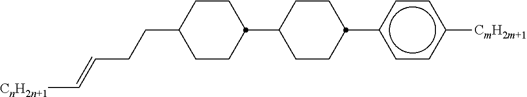

CCP-nV2-m

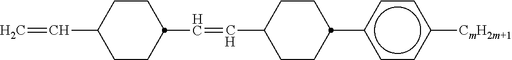

CVCP-V-m

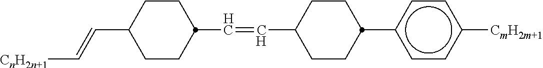

CVCP-nV-m

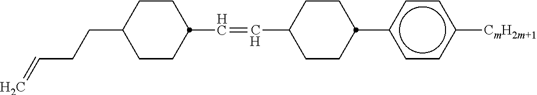

CVCP-V2-m

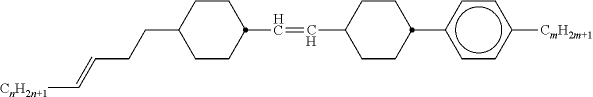

CVCP-nV2-m

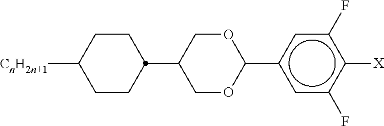

CDU-n-X
(X = F, Cl, “OT“ = OCF₃, “OD“ = OCF₂H, “T” = CF₃)

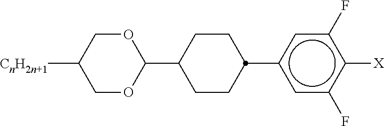

DCU-n-X
(X = F, Cl, “OT“ = OCF₃, “OD“ = OCF₂H, “T” = CF₃)

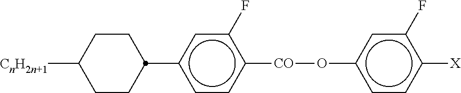

CGZG-n-X
(X = F, Cl, “OT“ = OCF₃, “OD“ = OCF₂H, “T” = CF₃)

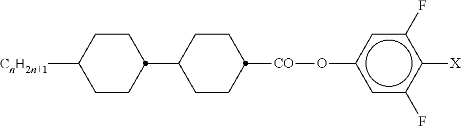

CCZU-n-X
(X = F, Cl, “OT“ = OCF₃, “OD“ = OCF₂H, “T” = CF₃)

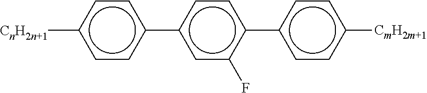

PGP-n-m

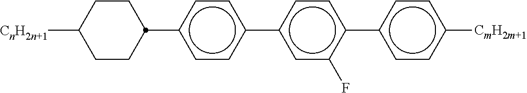

CPGP-n-m

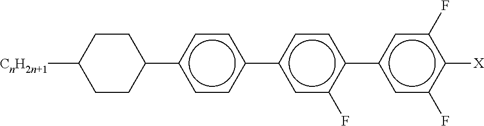

CPGU-n-X
(X = F, Cl, “OT“ = OCF₃, “OD“ = OCF₂H, “T” = CF₃)

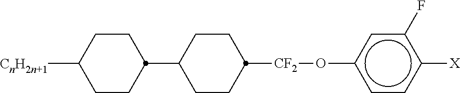

CCQG-n-X
(X = F, Cl, “OT“ = OCF₃, “OD“ = OCF₂H, “T” = CF₃)

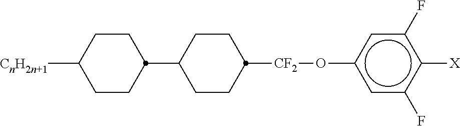

CCQU-n-X
(X = F, Cl, “OT“ = OCF₃, “OD“ = OCF₂H, “T” = CF₃)

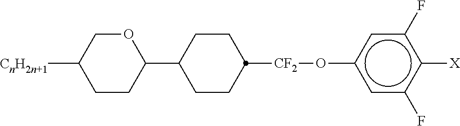

ACQU-n-X
(X = F, Cl, “OT“ = OCF₃, “OD“ = OCF₂H, “T” = CF₃)

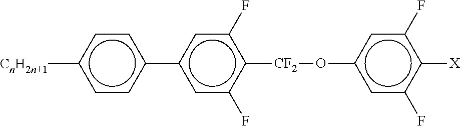

PUQU-n-X
(X = F, Cl, “OT“ = OCF₃, “OD“ = OCF₂H, “T” = CF₃)

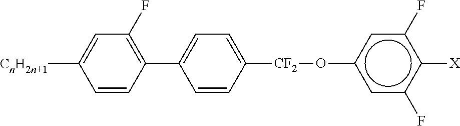

GPQU-n-X
(X = F, Cl, “OT“ = OCF₃, “OD“ = OCF₂H, “T” = CF₃)

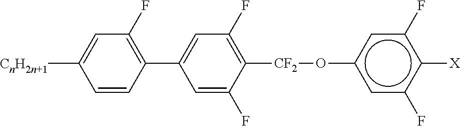

GUQU-n-X
(X = F, Cl, “OT“ = OCF₃, “OD“ = OCF₂H, “T” = CF₃)

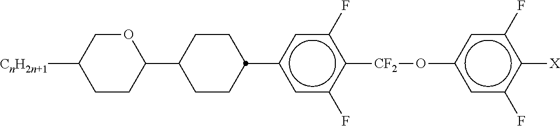

ACUQU-n-X
(X = F, Cl, “OT“ = OCF₃, “OD“ = OCF₂H, “T” = CF₃)

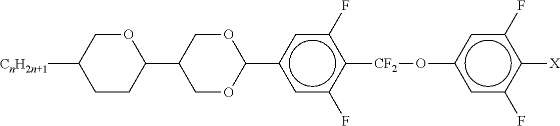

ADUQU-n-X
(X = F, Cl, “OT“ = OCF₃, “OD“ = OCF₂H, “T” = CF₃)

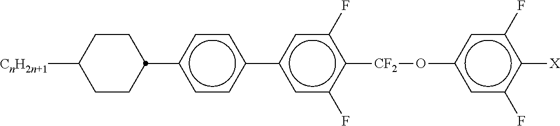

CPUQU-n-X
(X = F, Cl, “OT“ = OCF₃, “OD“ = OCF₂H, “T” = CF₃)

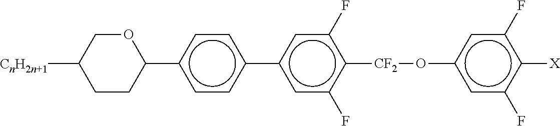

APUQU-n-X
(X = F, Cl, “OT“ = OCF₃, “OD“ = OCF₂H, “T” = CF₃)

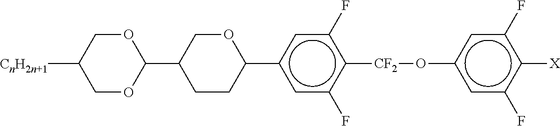

DAUQU-n-X
(X = F, Cl, “OT“ = OCF₃, “OD“ = OCF₂H, “T” = CF₃)

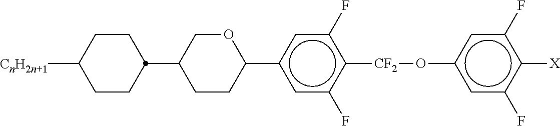

CAUQU-n-X
(X = F, Cl, “OT“ = OCF₃, “OD“ = OCF₂H, “T” = CF₃)

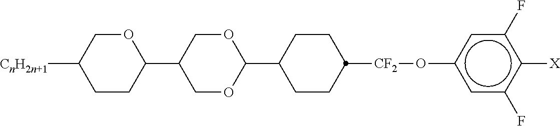

ADCQU-n-X
(X = F, Cl, “OT“ = OCF₃, “OD“ = OCF₂H, “T” = CF₃)

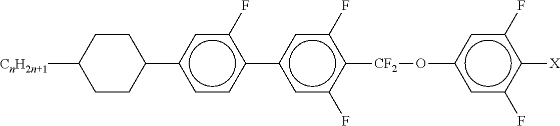

CGUQU-n-X
(X = F, Cl, “OT“ = OCF₃, “OD“ = OCF₂H, “T” = CF₃)

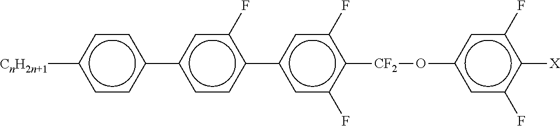

PGUQU-n-X
(X = F, Cl, “OT“ = OCF₃, “OD“ = OCF₂H, “T” = CF₃)

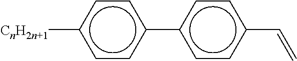

PP-n-V

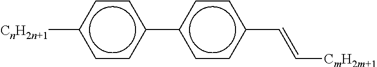

PP-n-Vm

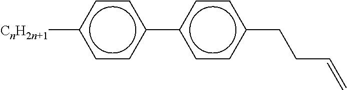

PP-n-2V

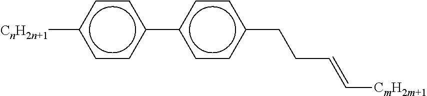

PP-n-2Vm

TABLE C

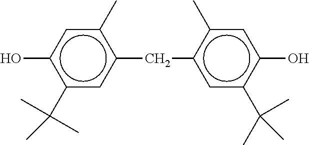

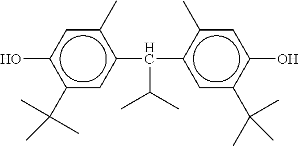

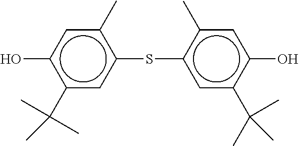

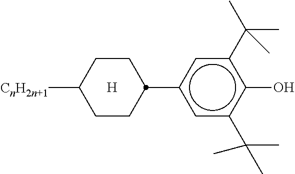

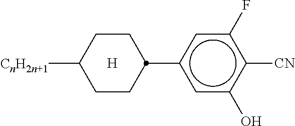

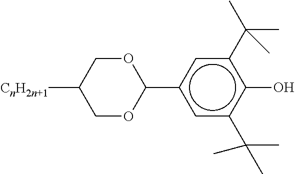

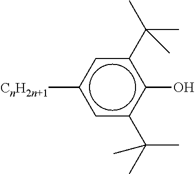

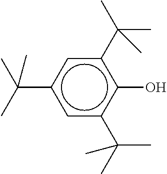

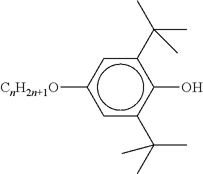

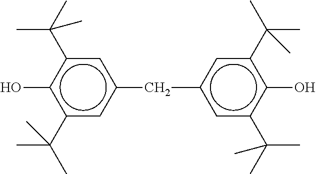

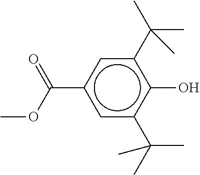

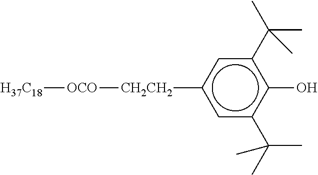

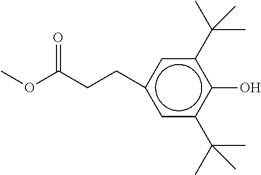

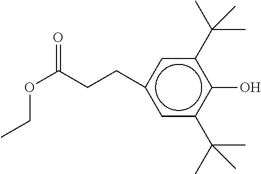

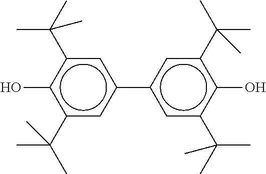

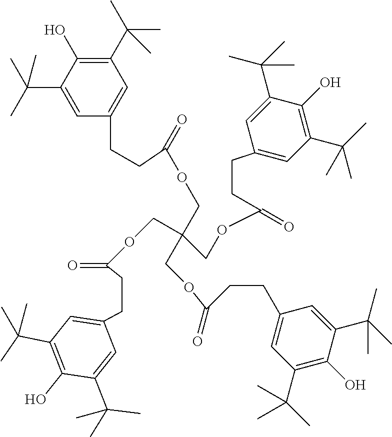 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O]

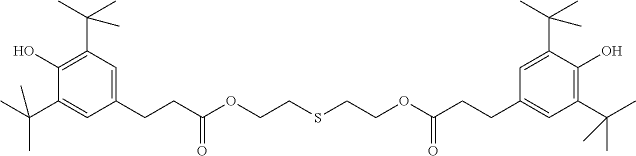 [SMILES: CC(C)(C)c1cc(CCC(=O)OCCSCCOC(=O)CCc2cc(C(C)(C)C)c(O)c(C(C)(C)C)c2)cc(C(C)(C)C)c1O]

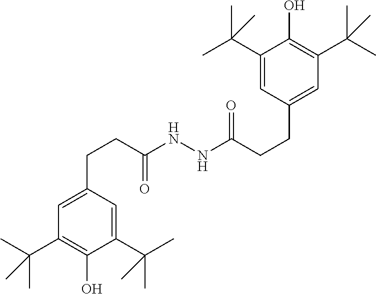 [SMILES: CC(C)(C)c1cc(CCC(=O)NNC(=O)CCc2cc(C(C)(C)C)c(O)c(C(C)(C)C)c2)cc(C(C)(C)C)c1O]

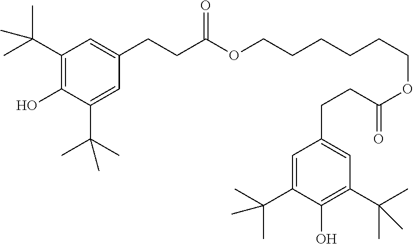 [SMILES: CC(C)(C)c1cc(CCC(=O)OCCCCCCOC(=O)CCc2cc(C(C)(C)C)c(O)c(C(C)(C)C)c2)cc(C(C)(C)C)c1O]

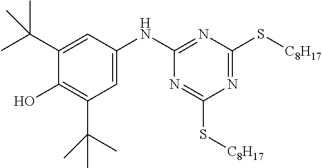

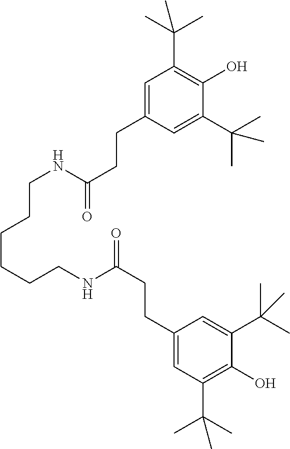 [SMILES: CC(C)(C)c1cc(CCC(=O)NCCCCCCNC(=O)CCc2cc(C(C)(C)C)c(O)c(C(C)(C)C)c2)cc(C(C)(C)C)c1O]

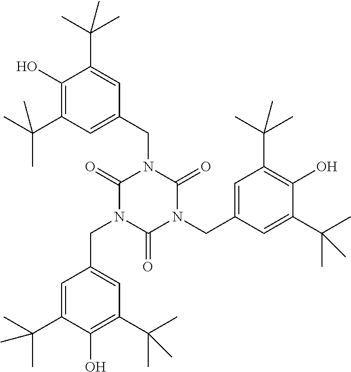 [SMILES: CC(C)(C)c1cc(Cn2c(=O)n(Cc3cc(C(C)(C)C)c(O)c(C(C)(C)C)c3)c(=O)n(Cc3cc(C(C)(C)C)c(O)c(C(C)(C)C)c3)c2=O)cc(C(C)(C)C)c1O]

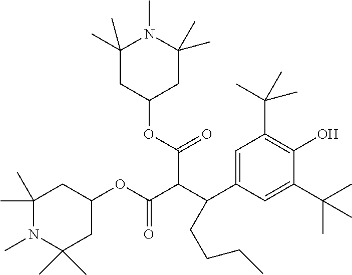 [SMILES: CCCCC(c1cc(C(C)(C)C)c(O)c(C(C)(C)C)c1)C(C(=O)OC1CC(C)(C)N(C)C(C)(C)C1)C(=O)OC1CC(C)(C)N(C)C(C)(C)C1]

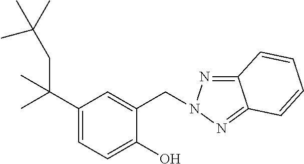 [SMILES: CC(C)(C)CC(C)(C)c1ccc(O)c(Cn2nc3ccccc3n2)c1]

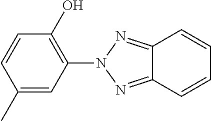 [SMILES: Cc1ccc(O)c(-n2nc3ccccc3n2)c1]

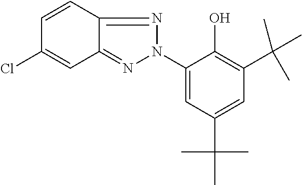 [SMILES: CC(C)(C)c1cc(-n2nc3ccc(Cl)cc3n2)c(O)c(C(C)(C)C)c1]

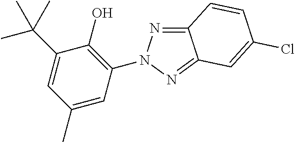 [SMILES: Cc1cc(-n2nc3ccc(Cl)cc3n2)c(O)c(C(C)(C)C)c1]

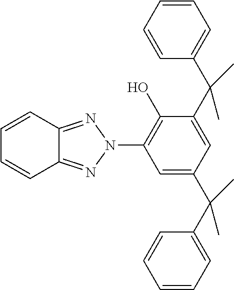 [SMILES: CC(C)(c1ccccc1)c1cc(-n2nc3ccccc3n2)c(O)c(C(C)(C)c2ccccc2)c1]

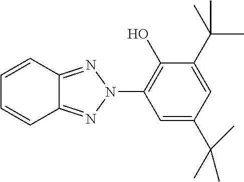 [SMILES: CC(C)(C)c1cc(-n2nc3ccccc3n2)c(O)c(C(C)(C)C)c1]

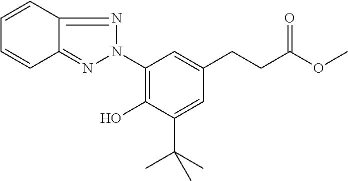 [SMILES: COC(=O)CCc1cc(-n2nc3ccccc3n2)c(O)c(C(C)(C)C)c1]

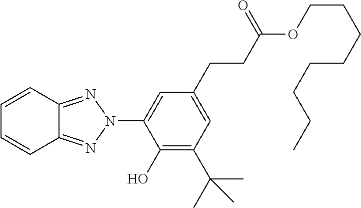 [SMILES: CCCCCCCCOC(=O)CCc1cc(-n2nc3ccccc3n2)c(O)c(C(C)(C)C)c1]

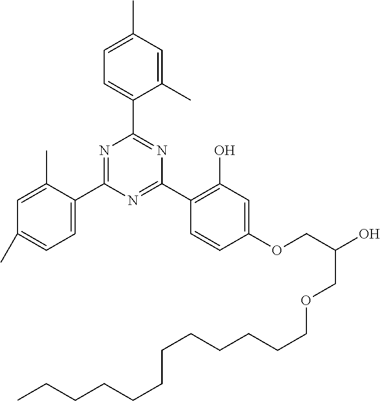 [SMILES: CCCCCCCCCCCCOCC(O)COc1ccc(-c2nc(-c3ccc(C)cc3C)nc(-c3ccc(C)cc3C)n2)c(O)c1]

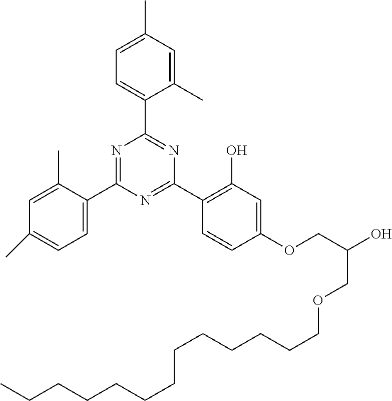 [SMILES: CCCCCCCCCCCCCOCC(O)COc1ccc(-c2nc(-c3ccc(C)cc3C)nc(-c3ccc(C)cc3C)n2)c(O)c1]

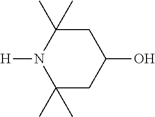

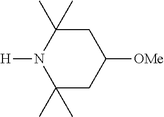

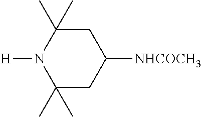

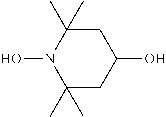

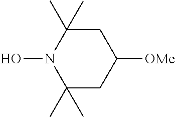

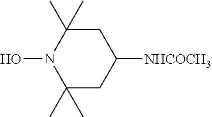

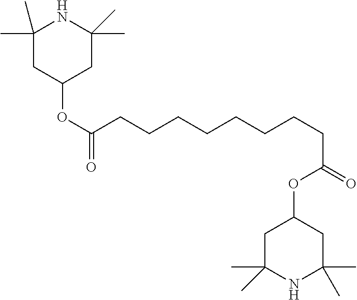

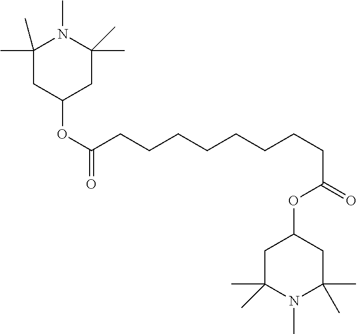

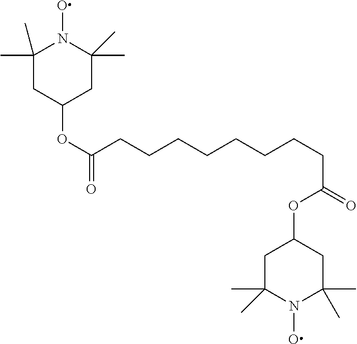

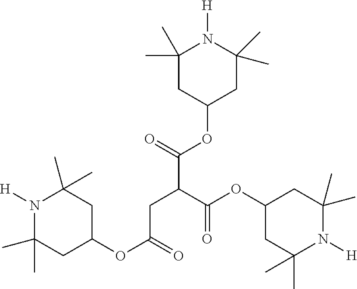

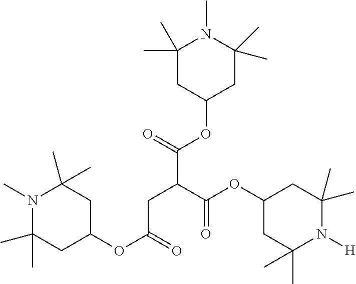

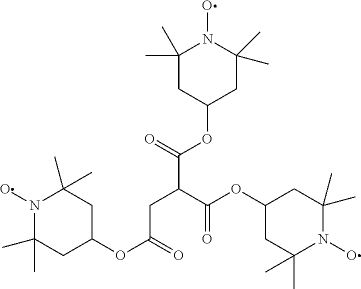

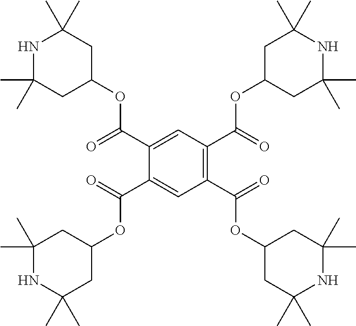

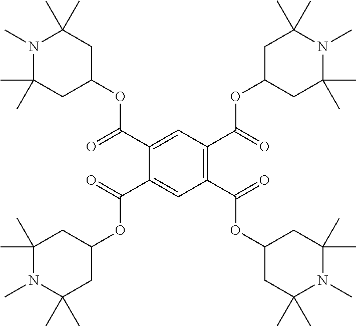

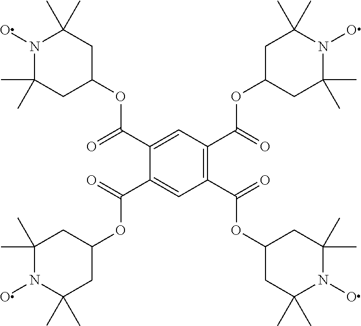

Table C shows possible stabilisers which can be added to the LC media according to the invention.

(n here denotes an integer from 1 to 12, preferably 1, 2, 3, 4, 5, 6, 7 or 8, terminal methyl groups are not shown).

The LC media preferably comprise 0 to 10% by weight, in particular 1 ppm to 5% by weight, particularly preferably 1 ppm to 1% by weight, of stabilisers. The LC media preferably comprise one or more stabilisers selected from the group consisting of compounds from Table C

The liquid crystal media according to the instant invention contain preferably
seven or more, preferably eight or more compounds, preferably of different formulae, selected from the group of compounds of tables A and B and/or
one or more, more preferably two or more, preferably three or more compounds, preferably of different formulae, selected from the group of compounds of table A and/or
three or more, more preferably four or more compounds, more preferably five or more compounds, preferably of different formulae, selected from the group of compounds of table B.

### EXAMPLES

The examples given in the following are illustrating the present invention without limiting it in any way.

However, the physical properties compositions illustrate to the expert, which properties can be achieved and in which ranges they can be modified. Especially the combination of the various properties, which can be preferably achieved, is thus well defined for the expert.

### Mixture Example 1

| | | | |
|---|---|---|---|
| CCH-23 | 18.00% | T_{(N,I)} [° C.]: | 74 |
| PCH-301 | 6.00% | Δn | 0.1107 |
| CG-V-1 | 3.00% | nₑ | 1.5903 |
| PUQU-3-F | 9.00% | Δε: | 11.7 |
| CCQU-3-F | 15.00% | ε_{\|\|}: | 15.5 |
| BCH-3F.F.F | 10.00% | γ₁ [mPa · s]: | 98 |
| CCP-30CF3 | 8.00% | LTS_{cell} (−20° C.) [h] | ≥840 |
| CCP-50CF3 | 7.00% | | |
| PGP-2-5 | 6.00% | | |
| APUQU-3-F | 8.00% | | |
| PGUQU-3-F | 7.00% | | |
| CPGU-3-OT | 3.00% | | |

### Mixture Example 2

| | | | |
|---|---|---|---|
| CCH-23 | 18.00% | T_{(N,I)} [° C.]: | 75.5 |
| PCH-301 | 6.00% | Δn | 0.1117 |
| CG-2V-1 | 3.00% | nₑ | 1.5909 |
| PUQU-3-F | 9.00% | Δε: | 11.9 |
| CCQU-3-F | 15.00% | ε_{\|\|}: | 15.8 |
| BCH-3F.F.F | 10.00% | γ₁ [mPa · s]: | 101 |
| CCP-30CF3 | 8.00% | LTS_{cell} (−20° C.) [h] | ≥528 |
| CCP-50CF3 | 7.00% | | |
| PGP-2-5 | 6.00% | | |
| APUQU-3-F | 8.00% | | |
| PGUQU-3-F | 7.00% | | |
| CPGU-3-OT | 3.00% | | |

### Mixture Example 3

| | | | |
|---|---|---|---|
| CCH-23 | 18.00% | T_{(N,I)} [° C.]: | 74 |
| PCH-301 | 6.00% | Δn | 0.1107 |
| CG-2V-1 | 3.00% | nₑ | 1.5907 |
| PUQU-3-F | 10.00% | Δε: | 11.8 |
| CCQU-3-F | 15.00% | ε_{\|\|}: | 15.7 |
| BCH-3F.F.F | 10.00% | | |
| CCP-30CF3 | 8.00% | | |
| CCP-50CF3 | 7.00% | | |
| PGP-2-5 | 6.00% | | |
| APUQU-3-F | 7.00% | | |
| PGUQU-3-F | 7.00% | | |
| CPGU-3-OT | 3.00% | | |

### Mixture Example 4

| | | | |
|---|---|---|---|
| BCH-32 | 5.00% | T_{(N,I)} [° C.]: | 72.5 |
| PUQU-3-F | 7.50% | Δn | 0.1298 |
| PGP-2-3 | 6.50% | nₑ | 1.6244 |
| PGP-2-4 | 6.50% | Δε: | 5.8 |
| PGP-2-5 | 8.00% | ε_{\|\|}: | 9.3 |
| CCQU-2-F | 2.00% | γ₁ [mPa · s]: | 83 |
| CCQU-3-F | 3.00% | LTS_{cell} (−20° C.) [h] | ≥1000 |
| CCQU-5-F | 2.50% | | |
| PCH-301 | 17.50% | | |
| CG-V-1 | 4.50% | | |
| CCH-23 | 13.50% | | |
| CCH-34 | 7.00% | | |
| CPGU-3-OT | 5.50% | | |
| CCGU-3-F | 5.50% | | |
| PGUQU-3-F | 5.50% | | |

### Mixture Example 5

| | | | |
|---|---|---|---|
| BCH-32 | 5.00% | T_{(N,I)} [° C.]: | 74.5 |
| PUQU-3-F | 7.50% | Δn | 0.1349 |
| PGP-2-3 | 6.50% | nₑ | 1.6310 |
| PGP-2-4 | 6.50% | Δε: | 5.7 |
| PGP-2-5 | 8.00% | ε_{\|\|}: | 9.3 |
| CCQU-2-F | 2.00% | γ₁ [mPa · s]: | 87 |
| CCQU-3-F | 3.00% | LTS_{cell} (−20° C.) [h] | ≥600 |
| CCQU-5-F | 2.50% | | |
| PCH-301 | 17.50% | | |
| CG-2V-1 | 4.50% | | |
| CCH-23 | 13.50% | | |
| CCH-34 | 7.00% | | |
| CPGU-3-OT | 5.50% | | |
| CCGU-3-F | 5.50% | | |
| PGUQU-3-F | 5.50% | | |

Mixture Examples 1 to 5 have a favourably low value of Δn, a high value of Δε and a low rotational viscosity. Thus, they are highly suitable for displays operating in the IPS mode. Furthermore, they have a very good stability of the nematic phase at deep temperatures.

1. Liquid crystalline medium, characterised in that it comprises one or more compounds of formula I 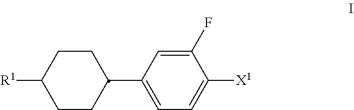
wherein
R¹ denotes alkenyl having 2 to 12 C atoms,
X¹ denotes H, F or alkyl having 1 to 6 C atoms.

2. Liquid crystalline medium according to claim 1, wherein the medium comprises one or more compounds of formula I of claim 1, wherein R¹ denotes alkenyl having 2 to 7 C atoms and X¹ denotes methyl.

3. Liquid crystalline medium according to claim 1, wherein the concentration of the one or more compounds of formula I is in the range of from 1% to 15% by weight.

4. Liquid crystalline medium according to claim 1, wherein the medium comprises one or more compounds selected from the group of compounds of the formulae II and III 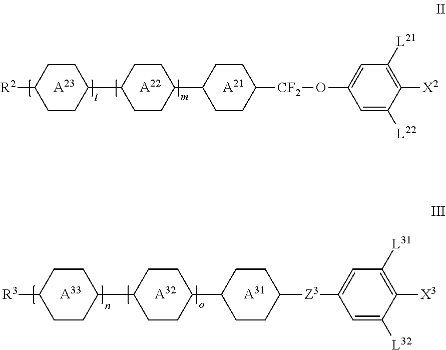
wherein
R² and R³ independently of each other, denote alkyl, alkoxy, fluorinated alkyl or fluorinated alkoxy with 1 to 7 C-atoms, alkenyl, alkenyloxy, alkoxyalkyl or fluorinated alkenyl with 2 to 7 C-atoms, 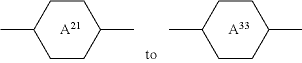
denote, independently of each other, 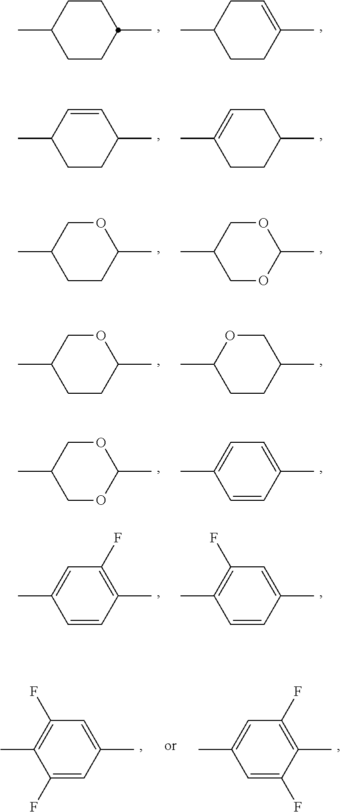
L²¹, L²², L³¹ and L³² independently of each other, denote H or F,
X² and X³ independently of each other, denote halogen, halogenated alkyl or alkoxy with 1 to 3 C-atoms or halogenated alkenyl or alkenyloxy with 2 or 3 C-atoms,
Z³ denotes —CH₂CH₂—, —CF₂CF₂—, —C(O)O—, trans-CH═CH—, trans-CF═CF—, —CH₂O— or a single bond,
l, m, n and o are, independently of each other, 0 or 1,
and wherein the compounds of formula I are excluded from the compounds of formula III.

5. Liquid crystalline medium according to claim 1, wherein the medium comprises one or more compounds of the formula IV 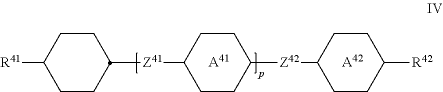
wherein
R⁴¹ and R⁴² independently of each other denote alkyl, alkoxy, fluorinated alkyl or fluorinated alkoxy with 1 to 7 C-atoms, alkenyl, alkenyloxy, alkoxyalkyl or fluorinated alkenyl with 2 to 7 C-atoms, 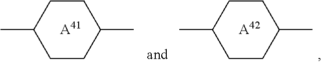
independently of each other, and in case 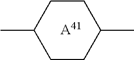
is present twice, also these, independently of each other, denote 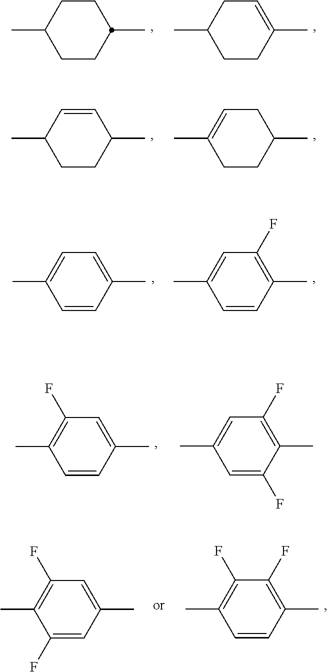
Z⁴¹, Z⁴² independently of each other, and in case Z⁴¹ is present twice, also these independently of each other, denote —CH₂CH₂—, —COO—, trans- —CH═CH—, trans- —CF═CF—, —CH₂O—, —CF₂O—, —C≡C— or a single bond, and
p is 0, 1 or 2,
and where compounds of formula I are excluded.

6. Liquid crystalline medium according to claim 1, wherein the medium comprises one or more compounds of the formula VI 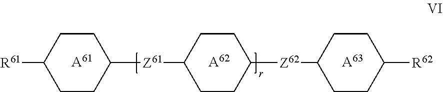
wherein
R⁶¹ and R⁶² independently of each other denote alkyl, alkoxy, fluorinated alkyl or fluorinated alkoxy with 1 to 7 C-atoms, alkenyl, alkenyloxy, alkoxyalkyl or fluorinated alkenyl with 2 to 7 C-atoms, 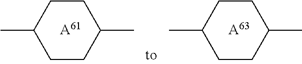
in each occurrence independently of each other, denote 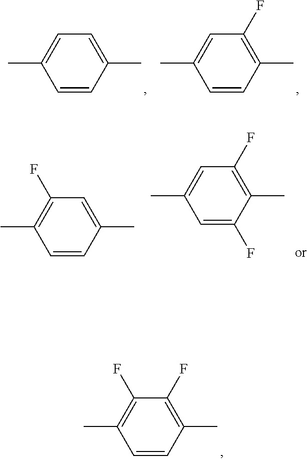
Z⁶¹ and Z⁶² are, independently of each other, and in case Z⁶¹ is present twice, also these independently of each other, —CH₂CH₂—, —COO—, trans- —CH═CH—, trans- —CF═CF—, —CH₂O—, —CF₂O— or a single bond, and
r is 0, 1 or 2.

7. Process for the preparation of a liquid-crystalline medium according to claim 1, characterised in that at least one compound of the formula I is mixed with at least one further mesogenic compound, and one or more additives and/or one or more stabilisers are optionally added.

8. (canceled)

9. Liquid crystal display, characterised in that it comprises a liquid crystal medium according to claim 1.

10. Liquid crystal display according to claim 9, characterised in that it is addressed by an active matrix.
